(19) United States
(12) Patent Application Publication
(10) Pub. No.: US 2020/0023280 A1
(43) Pub. Date: Jan. 23, 2020

(54) COMPUTER SYSTEM AND GAME SYSTEM

(71) Applicant: BANDAI NAMCO ENTERTAINMENT INC., Tokyo (JP)

(72) Inventors: Akio ONDA, Warabi-shi (JP); Katsunori YAMADA, Funabashi-shi (JP); Michiru TAKAHASHI, Tokyo (JP)

(73) Assignee: BANDAI NAMCO ENTERTAINMENT INC., Tokyo (JP)

(21) Appl. No.: 16/585,524

(22) Filed: Sep. 27, 2019

Related U.S. Application Data
(63) Continuation of application No. PCT/JP2018/012514, filed on Mar. 27, 2018.

(30) Foreign Application Priority Data
Mar. 31, 2017 (JP) 2017-071561

(51) Int. Cl. A63F 13/86; A63F 13/35; A63F 13/45; A63F 13/533; A63F 13/69; A63F 13/792; A63F 13/87

(52) U.S. Cl. CPC A63F 13/86; A63F 13/35; A63F 13/45; A63F 13/533; A63F 2300/609; A63F 13/792; A63F 13/87; A63F 2300/537; A63F 2300/577; A63F 13/69

(57) ABSTRACT

When a viewer executes a predetermined present operation, an item is selected from items that are possessed by the viewer, and is given to a player who is selected as a destination. Alternatively, an item that is purchased by the viewer is given to a player who is selected as a destination. When the player uses the presented item, a reward is given to the viewer who provided the present. This can make watching of gameplay images to be more attractive. Further, this allows the viewer to provide assistance more than cheering up to the player who performs the gameplay, and allows the viewer to feel a certain sense of unity with the player.

### CROSS REFERENCE TO RELATED APPLICATION

This application is a continuation of International Patent Application No. PCT/JP2018/012514, having an international filing date of Mar. 27, 2018, which designated the United States, the entirety of which is incorporated herein by reference. Japanese Patent Application No. 2017-071561 filed on Mar. 31, 2017 is also incorporated herein by reference in its entirety.

### BACKGROUND

Watching an image of gameplay by highly skilled players has been recognized as an entertainment equivalent to sports watching. Recently, this has been called “esports,” and gameplay images have been distributed to viewers widely collected. Techniques for distributing gameplay video have been known since before, and one of the techniques is disclosed in Japanese Unexamined Patent Application Publication No. 2009-247562.

According to such a known technique regarding gameplay image distribution as in JP-A-2009-247562, for example, a portable terminal device is used to facilitate watching how other players play games without going to an actual gameplay site such as an arcade.

However, in this case, the viewers are only watching the gameplay images. At this point, watching gameplay is the same as watching sports broadcasting. The relationship between the viewers and the players is merely a relationship between a cheering side and a side to be cheered, and the cheering side only engage in the gameplay by cheering for the players.

### BRIEF DESCRIPTION OF THE DRAWINGS

FIG. 1 is a diagram illustrating an example of a configuration of an esports watching system.

FIG. 2 is a front view of a user terminal, illustrating an example of a configuration thereof.

FIG. 3 is a diagram illustrating an outline of an esports watching.

FIG. 4 is a diagram illustrating giving a reward to a present provider when a viewer provides a present to a player.

FIG. 5 is a diagram illustrating a setting of queue rank in a present queue.

FIG. 6 is a diagram more specifically illustrating a setting of queue rank in a present queue.

FIG. 7 is a diagram illustrating giving an additional reward to a player when a viewer provides a present to a player.

FIG. 8 is a diagram illustrating giving an additional reward to a viewer when a viewer provides a present to a player.

FIG. 9 is a diagram illustrating an example of a play screen displayed on a user terminal (player terminal) for a player.

FIG. 10 is a functional block diagram illustrating an example of a functional configuration of a server system.

FIG. 11 is a diagram illustrating an example of programs and data stored in a server storage section.

FIG. 12 is a diagram illustrating an example of a data structure of game initial setting data.

FIG. 13 is a diagram illustrating an example of a data structure of provider reward defining data.

FIG. 14 is a diagram illustrating an example of a data structure of player reward defining data.

FIG. 15 is a diagram illustrating an example of a data structure of viewer reward defining data.

FIG. 16 is a diagram illustrating an example of a data structure of user management data.

FIG. 17 is a diagram illustrating an example of a data structure of distribution management data.

FIG. 18 is a diagram illustrating an example of a data structure of present provision history data.

FIG. 19 is a functional block diagram illustrating an example of a functional configuration of a user terminal.

FIG. 20 is a flowchart illustrating a flow of a process in the server system.

FIG. 21 is a flowchart illustrating a flow of a present process.

FIG. 22 is a flowchart illustrating a flow of a reward giving process.

### DESCRIPTION OF EXEMPLARY EMBODIMENTS

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

In accordance with one of some embodiments, there is provided a computer system comprising:

a processor; and

a storage device storing a program,

the processor executing the program for

providing information for displaying a gameplay image played by using an object based on a use operation of a player user on a viewer terminal of a viewer user;

performing an assistance control of giving the object for the assistance to the player user by accepting an assistance instruction for assisting the player user from the viewer terminal and giving the object from the viewer user to the player user; and

performing a reward giving control of giving a reward to a viewer user who gave the assistance object and/or to the player user based on whether the assistance object is used or not used by the player.

The “computer system” as used herein may be a system including a single computer or may be a system including a plurality of computers in communicable connection with each other.

According to the present embodiment, a viewer user can give an assistance object to a player user. Based on whether the assistance object is used or not, a reward is given to the person (viewer user) who provided the present and/or the side (player user) who received the present. That is, in an embodiment of the present disclosure, the viewer watching gameplay images can provide the player playing the gameplay with assistance more than a cheer. This can make watching of gameplay images to be more attractive. By providing an assistance more than a cheer and observing the assistance to become a benefit to the player, the viewer can feel a certain sense of unity with the player.

According to one of some embodiments,

in the computer system,

the assistance control including a control of selecting the assistance object among possessed objects of the viewer user according to the selection operation instruction by the viewer user and giving the assistance object to the player user.

With this configuration, the viewer user can select an object for a present as an assistance object among the possessed objects of the viewer. Accordingly, pleasure of considering what to give can be added. Note that the selection operation instruction can include an automatic selection direction of random selection.

According to one of some embodiments,

in the computer system,

the assistance control including a control of purchasing the assistance object and giving the assistance object to the player user according to a purchase operation instruction by the viewer user.

With this configuration, the viewer user can purchase an object that can serve as an assistance object.

In accordance with one of some embodiments, in the computer system, the processor executing the program for further controlling a progress of the game by changing exerted effects according to a timing of provision of the assistance object by the assistance control when a progress of the game is controlled by using the assistance object based on a use operation of the player user.

With this configuration, when, during gameplay, the player user uses the assistance object that is given to the player user, an effect set in the assistance object is exerted during gameplay. The exerted effect of the assistance object becomes different according to a timing at which the assistance object is given. Hence, the viewer user should think of the timing to perform assistance instruction of giving the assistance object while considering a change in the exerted effect. This enhances interests in giving an assistance object and pleasure of assistance.

According to one of some embodiments,

in the computer system, the reward giving control including changing a content of the reward according to a timing of provision of the assistance object by the assistance control when the assistance object is used.

With this configuration, when a reward is given to the viewer user who gave the assistance object used by the player user, the content of the reward changes according to the timing at which the assistance object is given. Hence, the viewer user should think of the timing for giving the assistance object. This further enhances interests in giving the assistance object, and pleasure of assistance is increased more than ever.

According to one of some embodiments,

in the computer system,

the assistance control including accepting the assistance instruction from a plurality of the viewer users; giving a plurality of the assistance objects to the player user,

the processor executing the program for further performing a selection list control that variably controls a display rank of the assistance object, the assistance object being displayed in a selection list when the player user selects the assistance object for use in the game.

With this configuration, in a selection list of the given assistance objects to be selected for use by the player user, the display rank of the assistance object can be changed. For example, when options are displayed in a right-left or top-down arrangement, the player user tends to select more often an option that is within a range of a firstly displayed selection list. In other words, such option tends to have a high rate of probability of selection. Hence, by variably controlling the display rank, the frequency of selection of the assistance object can be controlled.

According to one of some embodiments,

in the computer system, the selection list control including variably controlling the display rank according to a timing at which the assistance object is given by the assistance control.

With this configuration, the display rank in the selection list changes depending on the timing of giving the assistance object. This changes frequency and probability of selecting the assistance object for the player user. Hence, the viewer user can think of at which timing the assistance object should be given. This enhances interests in presenting an assistance object and pleasure of assistance.

According to one of some embodiments,

in the computer system, the assistance control including accepting the assistance instruction and giving the assistance object to the player user, the assistance instruction being performed as a whole in one operation or automatically used intermittently or continuously with a package as a unit,

the selection list control including variably controlling the display rank with a package of the assistance object as a unit.

With this configuration, a plurality of assistance objects in one assistance instruction (i.e., giving a present once) can be regarded as one package, and can be displayed as an option in the selection list.

According to one of some embodiments,

in the computer system, the selection list control including variably controlling the display rank according to a content of the package of the assistance object.

With this configuration, the display rank in the selection list can change depending on a type of assistance object included in the package. Hence, the viewer user can select assistance objects that are given collectively at one time. This enhances interests in presenting an assistance object and pleasure of assistance

According to one of some embodiments,

in the computer system, the selection list control including variably controlling the display rank according to whether a relationship between the viewer user who gave the assistance object and the player user is a predetermined relationship.

A predetermined relationship can be defined as appropriate depending on the content of the game. For example, the relationship can be defined by a binary condition of whether the relationship is a friend or not or whether compatibility is good or bad, or defined by terms such as “intimacy”, “reliability”, or “friendship level”. According to the present embodiment, the relationship between a viewer user and a player user affects the change in the display rank.

According to one of some embodiments,

in the computer system, the selection list control including variably controlling the display rank according to intimacy between the viewer user who gave the assistance object and the player user.

With this configuration, the display rank can be changed depending on the intimacy between a viewer user and a player user. For example, if the display rank is changed such that the assistance object provided by a viewer user having a higher intimacy is displayed at a position in which the player user can more often select, the assistance provided by an intimate person can be used more often. This allows the viewer user to feel increased sense of unity with the player.

According to one of some embodiments,

in the computer system, the reward giving control including giving a reward as the reward of increasing the intimacy between the viewer user who gave the assistance object and the player user when the assistance object is used.

With this configuration, intimacy can be increased as a reward. When intimacy is increased, the display rank of the subsequent assistance object is changed advantageously to create virtuous circle. This allows the viewer user providing the assistance object to further feel motivation for assistance and to encourage executing additional assistance. The more viewers provide more assistance, the more the player can use the assistance. Hence, the game becomes enlivened. As a result, the viewer user can have an enjoyable time, and the player can also have an enjoyable time by fully playing the game.

According to one of some embodiments,

in the computer system, the reward giving control including changing a content of the reward based on a result of the game.

With this configuration, the content of the reward can be changed depending on the result of a gameplay that is a target for watching. If the content of the reward is changed to be more beneficial to the viewer user who provides the assistance object to the player user when the player user has a good result, a degree of putting emphasis may change to encourage assistance more actively.

According to one of some embodiments,

in the computer system, the reward giving control including changing a content of the reward based on a type and/or quantity of the assistance object that has been used in the game.

With this configuration, the kinds and number of assistance objects affect the content of the reward. This increases the importance of selection of the assistance object, and thus helps increase fulfillment of assistance and interests.

According to one of some embodiments,

in the computer system,

the processor executing the program for further implementing notification which is performed to the player terminal of the player user every time the assistance object is given to the player user by the assistance control.

With this configuration, the player user who focuses on the play can be notified that the assistance object is given.

In accordance with one of some embodiments, there is provided a game system comprising a server system that is the computer system, and the viewer terminal.

Exemplary embodiments are described below. Note that the following exemplary embodiments do not in any way limit the scope of the content defined by the claims laid out herein. Note also that all of the elements described in the present embodiment should not necessarily be taken as essential elements.

An exemplary embodiment of the present disclosure is described below. It is a matter of course that modes to which the present disclosure can be applied are not limited to the embodiments described below.

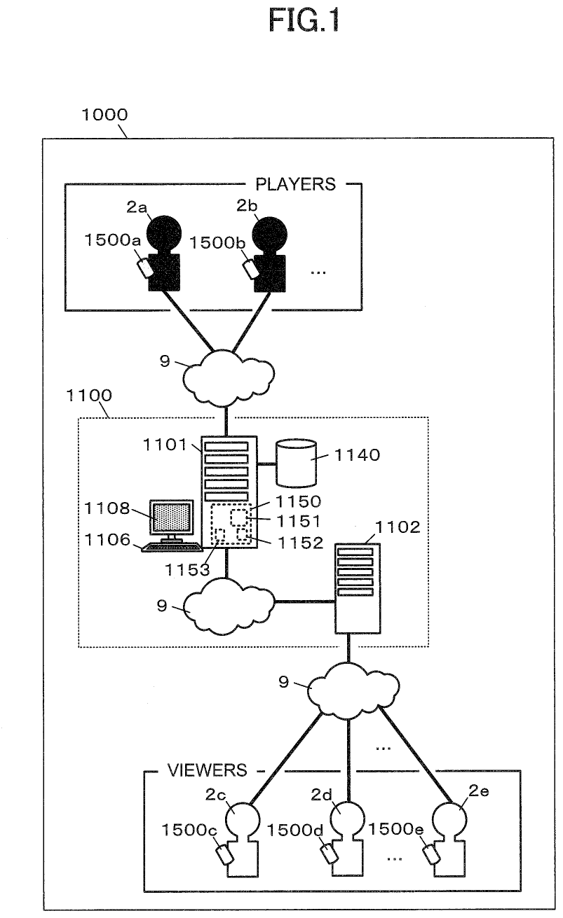

FIG. 1 is a diagram illustrating an example of a configuration of a game system according to the present embodiment. A game system 1000 according to the present embodiment is a system also serving as an esports watching system, and includes a server system 1100 and a plurality of user terminals 1500 (1500a, 1500b, . . . ) that can be connected to a communication line 9 to communicate with each other to exchange data. That is, the game system 1000 is a content providing system to provide contents roughly divided into two kinds, namely, online games and esports watching.

The “esports” as used herein is an abbreviation of electronic sports. Of registered users related to a game title, one or a plurality of users 2 (2a and 2b, in the example illustrated in FIG. 1) are set as “players” (occasionally referred to also as participants or clans) whereas one or a plurality of users 2 (2c, 2d, and 2e in the example illustrated in FIG. 1) are set as “viewers.” The “esports watching” as used herein is that the viewers watch how the players play a game.

The game system 1000 according to the present embodiment also functions as an esports watching system to collect, generate, and distribute information required for the esports watching and implements the watching.

The communication line 9 is a communication channel that enables data communications. Specifically, the communication line 9 includes a communication network such as a local area network (LAN) using a private line (private cable) for direct connection, Ethernet (registered trademark), and the like, a telecommunication network, a cable network, and the Internet. The communication method may be a cable communication method or a wireless communication method.

The server system 1100 is a computer system including a game server 1101 that functions as a game server to provide, as an online game, a game title to be a main content of esports, a storage 1140, and a distribution server 1102 that collects, generates, and distributes information required for the esports watching and implements the watching. The server system 1100 also includes a keyboard 1106 for an administrator and a touch panel 1108.

The game server 1101 includes a control board 1150. The control board 1150 contains a microprocessor of various types (e.g., a central processing unit (CPU) 1151, a graphics processing unit (GPU)), and a digital signal processor (DSP), an IC memory 1152 of various types (e.g., a video random access memory (VRAM), a random access memory (RAM), and a read only memory (ROM)), and a communication device 1153. The control board 1150 may partially or entirely be implemented with an application specific integrated circuit (ASIC), a field-programmable gate array (FPGA), and a system on a chip (SoC).

Through a calculation process performed by the control board 1150 based on a predetermined program and data, the game server 1101 implements 1) a user management function related to user registration and the like, 2) a game management function of providing data required to play the game with the user terminals 1500 (1500a, 1500b, . . . ) to manage execution control on the game played with the user terminals 1500 (1500a, 1500b, . . . ), and 3) an online shopping function of selling various items, usable in the game, to users online. Thus, the game according to the present embodiment is implemented as one type of client-server online games.

As functions related to the esports watching, the game server 1101 implements 4) a setting registration function of players and viewers, 5) a watching data preparation function of preparing watching data (or basic data required to generate the watching data) to implement the esports watching with the user terminals 1500 of the viewers, and 6) an accounting function of collecting watching cost and paying game cost. Functions implemented with the game server 1101 are not limited to these, and other types of functions may be added or any of these types of functions may be omitted as appropriate.

The distribution server 1102 includes a control board equivalent to the control board 1150 of the server system 1100. Through a calculation process performed based on a predetermined program and data, the distribution server 1102 implements a function of distributing watching data to the user terminals 1500 of the viewers and a function of collecting various requests from the user terminals 1500 and transmitting the requests to the game server 1101. Functions of the distribution server 1102 are not limited to these, and any of these types of functions may be omitted or other types of functions may be added as appropriate. For example, the distribution server 1102 may have an additional function of generating watching data based on the basic data provided by the game server 1101.

The server system 1100 may be implemented as a single server. Alternatively, a plurality of blade servers, in charge of various functions, may be installed while being connected to each other via an internal bus to be capable of performing data communications with each other. Furthermore, a plurality of independent servers, disposed in locations distant from each other, may perform data communications with each other via the communication line 9 to function as the server system 1100 as a whole. In FIG. 1, the game server 1101 and the distribution server 1102 are illustrated as separate units. However, the game server 1101 and the distribution server 1102 may each include a blade server, and be disposed and managed as an integral device.

The user terminals 1500 (1500a, 1500b, . . . ) are computer systems individually usable by registered users as players and viewers to play and watch the game, and are electronic devices (electronic apparatuses) that can access the server system 1100 via the communication line 9 to implement an online game. The user terminals 1500 used by players are referred to as player terminals, and the user terminals 1500 used by viewers are referred to as viewer terminals.

Each of the user terminals 1500 according to the present embodiment is a device known as a smartphone. The user terminal 1500 may also be a portable game device, a game controller, a personal computer, a tablet computer, a wearable computer, an arcade game device, or the like.

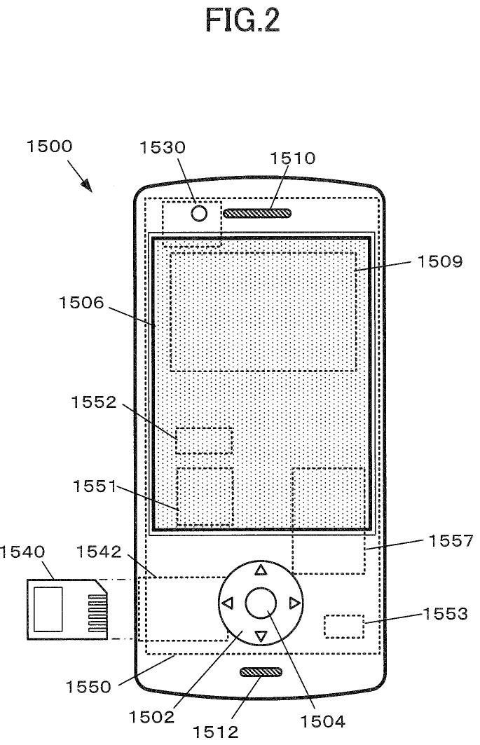

FIG. 2 is a front view of the user terminal 1500 according to the present embodiment, illustrating an example of a configuration thereof.

The user terminal 1500 includes an arrow key 1502, a button switch 1504, a touch panel 1506 that functions as an image display device and a touch position input device, a speaker 1510, a built-in battery 1509, a microphone 1512, an image sensor unit 1520, a control board 1550, and a memory card reader 1542 that can write and read data on and from a memory card 1540 that is a computer readable storage medium. The user terminal 1500 further includes a power button, a volume control button, and the like (not illustrated). Furthermore, the user terminal 1500 may be provided with an IC card reader that can implement contactless writing and reading of data on and from an IC card, such as a credit card or a prepaid card, usable for payment involved in playing the game.

The control board 1550 includes a microprocessor of various types (e.g., the CPU 1551, a GPU, and a DSP), an IC memory 1552 of various types (a VRAM, a RAM, and a ROM), a wireless communication module 1553 for performing wireless communications with a mobile phone base station, a wireless LAN base station, or the like connected to the communication line 9, an interface circuit 1557, and the like.

The interface circuit 1557 includes, for example, a driver circuit that drives the touch panel 1506, a circuit that receives signals from the arrow key 1502 and the button switch 1504, an output amplifier circuit that outputs a sound signal to the speaker 1510, an input signal generation circuit that generates a signal corresponding to the sound collected by the microphone 1512, a circuit that inputs image data of an image captured by the image sensor unit 1520, and a signal input-output circuit that inputs and outputs a signal to and from the memory card reader 1542.

The elements mounted on the control board 1550 are electrically connected with each other via a bus circuit or the like to be capable of exchanging data and signals. The control board 1550 may partially or entirely be implemented with an ASIC, an FPGA, or a SoC. The control board 1550 stores, in the IC memory 1552, programs and various types of data for implementing a function as a gameplay terminal and a function as an esports watching terminal.

A client program and various types of setting data are downloaded by the user terminal 1500 from the server system 1100 in the present embodiment. The program and the data may also be read from a storage medium such as the memory card 1540 additionally provided.

[Game Description]

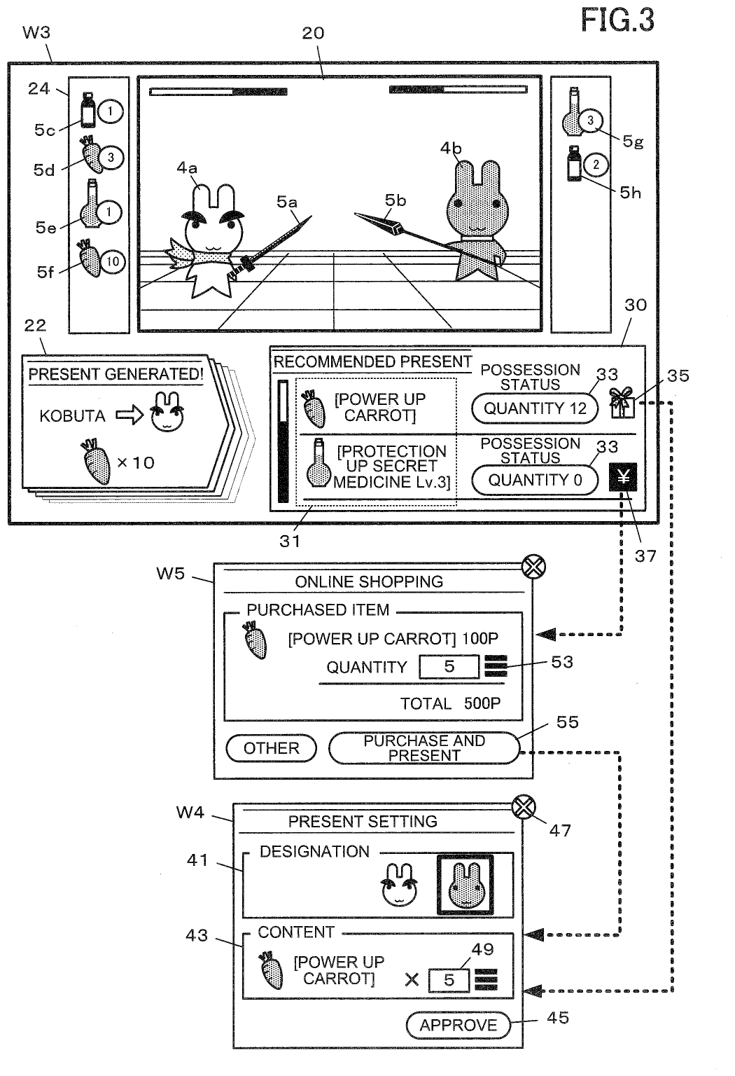

FIG. 3 is a diagram illustrating an outline of contents for the esports watching according to the present embodiment to show an example of a screen display for the esports watching.

The game content provided by the game system 1000 according to the present embodiment is an online game played by a player user. In the online game, a given object exhibits a given effect when the player user uses the given object based on use operation.

The “object” as used herein is a game element possessed by the user for the gameplay that can be used, sold, or given to others. For example, the object includes a character and an item that appear in the game. A game parameter, a skill, an exercisable trick, and the like may be included according to the details of the game. For example, a parameter value such as vitality or a vitality point that is given and accumulated automatically to the player according to time lapse and payed in exchange for the play operation, and a parameter value of the player character (for example, hit point, possessed magical power, traveling force, and the like) may be treated as an object. Specifically, “5 points of vitality point” may be treated as one object.

In the game contents according to the present embodiment, a character and an item are used as objects. That is, the game according to the present embodiment is a competition game in which the users 2 as players compete against each other by manipulating player characters 4 (4a, 4b, . . . ; a character object) possessed by the users, and equipping the player characters 4 with items 5 (5a, 5b, . . . ; an item object) possessed by the users and using the items 5 during play. The game that is a target of watching according to the present embodiment is the same game content.

An example of a one-to-one competition game is described herein, however, the game may be in a multiplayer, many-to-many survival mode and a team competition mode. The content of the competition may be not only fighting but also real-time strategy, shooting, racing, and the like.

When a game client program is booted and an esports watching mode is selected on the user terminal 1500 of the viewer according to the schedule of viewable esports, a watching screen W3 is displayed on the touch panel 1506.

The watching screen W3 includes a play screen display section 20, a present operation section 30, a present generation notification 22, and a present stock display section 24 for each player. Note that contents other than these may be included as appropriate.

The play screen display section 20 displays a subject image for watching, that is, an image of a situation of gameplay played by the players. In the present embodiment, the player character 4 of each player is displayed before starting the play and during the play. The display includes not only a situation of equipping an item 5 of a weapon such as a sword and a spear before starting the play but also a situation of fighting during the play.

A method of displaying an image in the play screen display section 20 can be selected as appropriate. For example, the game server 1101 may dispose an object of each player character 4 in a game space, which is a three-dimensional virtual space, and control operating the object, and the game server 1101 may also generate an image in the three-dimensional virtual space in real time by capturing the image from a predetermined distribution point-of-view so as to provide the image for streaming distribution. Alternatively, the operation input information of the player may be distributed to the viewer's user terminal 1500, and the play image may be generated at each user terminal based on the distributed operation input information. In the present embodiment, the former of the two methods, namely, streaming distribution will be described.

In the game system 1000 according to the present embodiment, the viewer can assist an intended player (or an intended player team depending on the game content) before the play and during the play.

The present operation section 30 displays various information for the viewer to assist the player. In the present embodiment, presenting an item 5 possessed by the viewer (a possessed object, a possessed item; a possessed object in the present embodiment) to the player is adopted as an assistance executable by the viewer. The present operation section 30 provides information for reference in executing providing a present, and displays an element for inputting a selection operation instruction in executing providing a present.

Specifically, the present operation section 30 includes a recommended information display 31, a possession status display 33, a possessed item present execution operation icon 35 and a spot purchase and present execution operation icon 37.

The recommended information display 31 offers an item that may be useful for the user (player) who will be given the present depending on the situation of the play at each occasion. Specifically, the item list is sorted and displayed in the order of recommendation from the upper rank. In the limited area of the present operation section 30, not all items are displayed, however, the items that are not displayed can be displayed by sliding operation inside the operation section.

The possession status display 33 is displayed by one-to-one correspondence with the item displayed in the recommended information display 31 (in the example illustrated in FIG. 3, the correspondence is displayed side by side), and a situation of the item possessed by the viewer who uses the user terminal is displayed. In the present embodiment, a possessed quantity is displayed.

The possessed item present execution operation icon 35 is for accepting an operation input for a first assistance instruction. Specifically, input of the selection operation instruction for starting a procedure of presenting a possessed object displayed in the corresponding possession status display 33 to the player as an assistance item (assistance object) is accepted. Then, by a touch operation of the operation icon, a present detail setting screen W4 is displayed on the user terminal 1500.

The present detail setting screen W4 includes a destination designation section 41 for designating the destination of the present, in other word, the player for giving the present, a content designation section 43 for setting the types and the quantity of the present items, a confirmation operation icon 45 for performing confirmation operation of present execution, and a cancellation operation icon 47 for closing or the screen or cancelling the present.

The destination designation section 41 displays the player character 4 (4a, 4b) or an avatar of the player. The viewer can touch any of the above to set the destination of the present.

The content designation section 43 displays a possessed item as a present item by default. The possessed item is shown in the possession status display 33 that corresponds to the possessed item present execution operation icon 35. The viewer can select and set the quantity of items that may be presented simultaneously by operating a provision quantity setting section 49. The contents of present specified herein, that is, the types and the quantity of the present items are treated as one package.

By operating the confirmation operation icon 45, presenting of the content specified as above to the designated destination at that time is executed. On the contrary, by operating the cancellation operation icon 47, presenting is cancelled regardless of the destination designated at that time and the contents.

The spot purchase and present execution operation icon 37 is for accepting an operation input for a second assistance instruction. Specifically, this icon is displayed instead of the possessed item present execution operation icon 35 if the viewer does not possess the displayed item corresponding to the possession status display 33. Then, spot purchase of the displayed item corresponding to the possession status display 33 is performed by using the online shopping function, and an operation input of starting present execution procedure is accepted. Then, by a touch operation of the operation icon, a shopping screen W5 is displayed on the user terminal 1500.

The shopping screen W5 is for purchase operation of the present item, and displays the item displayed in the possession status display 33 by default. The viewer can select and set the quantity of items that may be purchased by operating a purchase quantity setting section 53. By operating a purchase confirmation operation icon 55, the purchase operation is regarded as being instructed and purchase of the set content is executed. Then, the present detail setting screen W4 in which the purchased item is set as a present by default is displayed. Then, in the same manner as above description, presenting is executed.

That is, the item possessed (or additionally purchased and possessed on the spot) by the viewer (who operates presenting) is deleted and given to the designated player instead.

When the item present is executed by the viewer, the present generation notification 22 is newly displayed on the watching screen W3. The present generation notification 22 includes information on the viewer who provided the present (such as a handle and the like), information on the destination of the present, the types and the quantity of the present items, that is, the contents of the package of the items (the package of the assistance object).

When the item present is executed by the viewer, the present received by each player is disclosed according to the package on the present stock display section 24.

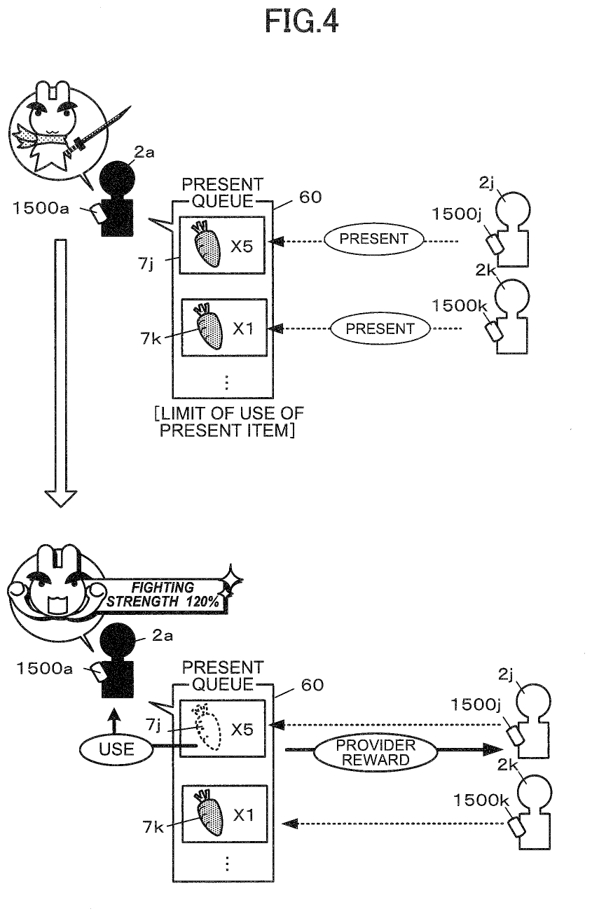

FIG. 4 is a diagram illustrating giving a reward to a present provider when a viewer provides a present to a player. The package (a package 7j and 7k in the example illustrated in FIG. 4) of a present received by a player (a user 2a in the example illustrated in FIG. 4) is stored in a present queue 60 for management. The item 5 presented in a package unit is displayed for the player to use the item 5 in the present queue 60 in the order of first-in-first-out method.

All the present in a package unit can be used as a whole in one operation (for example, spent), or can be used continuously or intermittently during use operation. Alternatively, the present can be used at a predetermined quantity for each use operation. In the present embodiment, the present in a package is used at a predetermined quantity for each use operation. When all the presented items in the package are used, the package reaches use completion and is deleted from the present queue 60.

When the presented item is used by the player (specifically, the package reaches use completion), a reward is given to the viewer who provided the used present. This is referred to as a “provider reward”. In the example illustrated in FIG. 4, the package 7j achieves completion of use, and the provider reward is given to a user 2j who has provided the package of the present.

The content of “a provider reward” may be set as appropriate. For example, the setting can include giving an item and a character, giving a payment medium (for example, virtual currency points, particular kinds of items, etc.) for use in an electronic payment of costs of playing game contents and online shopping, giving a skill or an increase in ability of the player character 4, giving a charged or free lottery ticket, giving a right of opening a new game stage, giving a coupon, increasing a relationship degree between the player who receives the present and the viewer who gives the present.

The “relationship degree” as used herein can be set, for example, as a friendship level in which the two parties each are registered as a friend. The usage of the friendship level may be set as appropriate. For example, the friendship level can be applied when the two parties play a multiplayer game in a way such that the higher the value of the friendship level is, the more advantageously the player can play the game. Specifically, the friendship level can be used such that when the two parties play FPS in the same team, the rate of being shot by an enemy decreases depending on the friendship level.

In the present embodiment, the present queue 60 prepares the item to become a present classified by types, however, the quantity of the present queues 60 may be limited and a plurality of types of the item to become a present may be contained in a mixed manner.

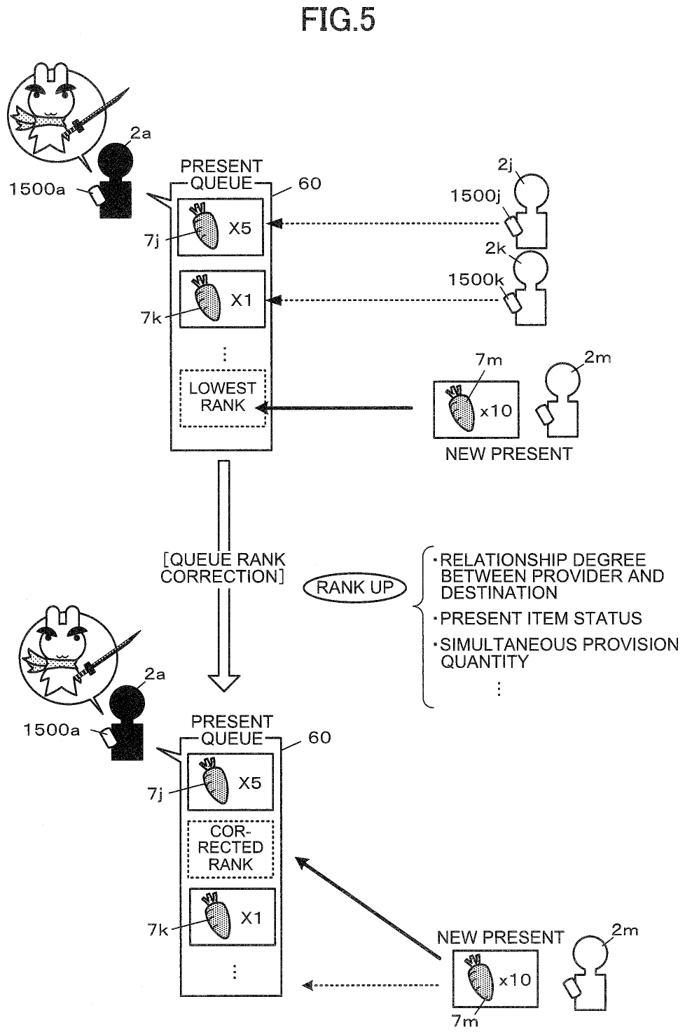

FIG. 5 is a diagram illustrating a setting of the queue rank in the present queue 60. The present queue 60 adopts a first-in-first-out method for data management as described above. Hence, basically, a new present is set at the lowest rank (tail end).

However, the present embodiment includes a mechanism of setting or changing the queue rank.

Specifically, an initial value of the queue rank applied to the new present is set based on a given parameter value for setting initial value. Then, the rank of the initial value is changed to be raised based on a given changing parameter value. Thus, the new present is inserted into the present queue 60 and registered according to the changed and corrected queue rank.

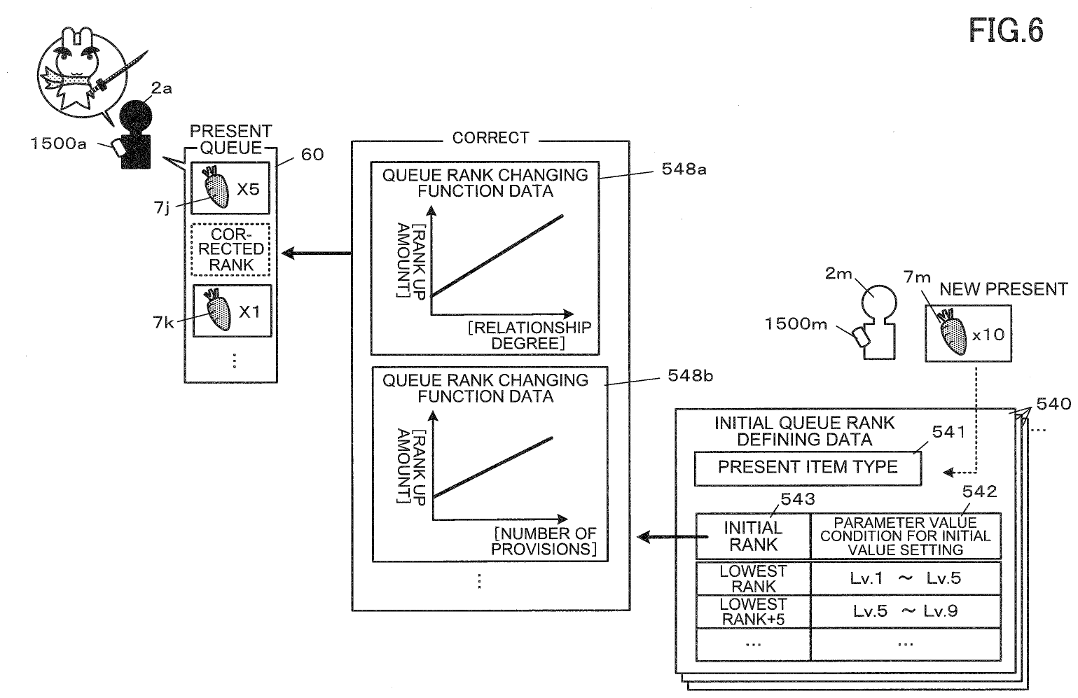

Specifically, as shown in FIG. 6, an initial queue rank defining data 540 is prepared by item types that may be a present item. In the defining data, a parameter value condition 542 for setting initial value and an initial rank 543 are defined in association.

For the “parameter value for setting initial value”, the relationship degree between the provider of the new present and a receiver of the present, an ability parameter value of a newly presented item (for example, rarity, an item level, a purchase price, an attack improvement rate, frequency of use, etc.), the quantity of newly provided presents, the number of times and the quantity of presents that the provider of the new present has performed in the past, frequency of execution of presents, and the like may be adopted. The larger the above values, the higher the initial value of the queue rank is set.

Also, a queue rank changing function data 548 (548a, 548b, . . . ) is prepared for changing and correcting the queue rank. The initial value of the queue rank is changed according to the above function data and the applied queue rank is determined.

The queue rank changing function data 548 is prepared by the “changing parameter value”. The larger the parameter values, the higher the initial value of the queue rank is set. For the changing parameter value, the same content of the parameter value for setting initial value can be adopted as appropriate.

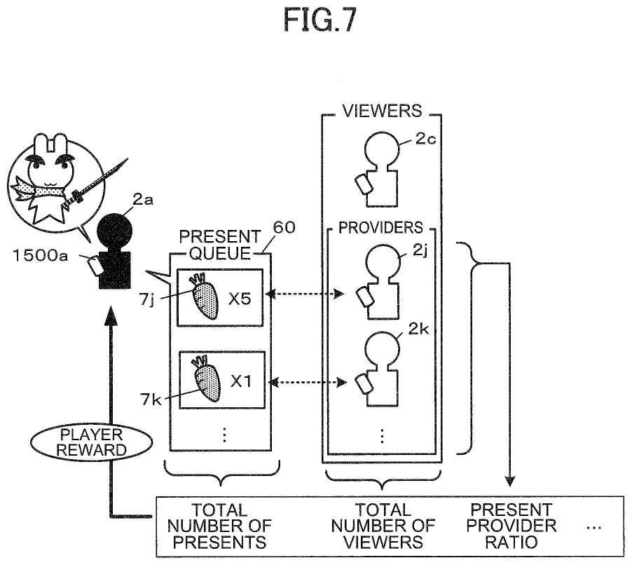

FIG. 7 is a diagram illustrating giving an additional reward to a player when a viewer provides a present to a player. In the present embodiment, the reward is given to the provider of the present used by the player as described above. The reward is also given to the player (the user 2a in FIG. 7) when a predetermined reward giving condition is satisfied. The additional reward as a first additional reward is referred to as a “player reward”.

The “reward giving condition” as used herein is described as AND or OR relationship of a single element or a plurality of elements, such as a total number of presents that the player received, a rate of usage of the received presents, a total number of viewers, a rate of present providers to the total number of viewers, a play result of the player, and the like. Note that contents other than these may be used as an element for describing a reward giving condition.

The content of the “player reward” may be set as appropriate. For example, the reward can be considered in the same manner as the reward for the present provider who provided the present used by the player.

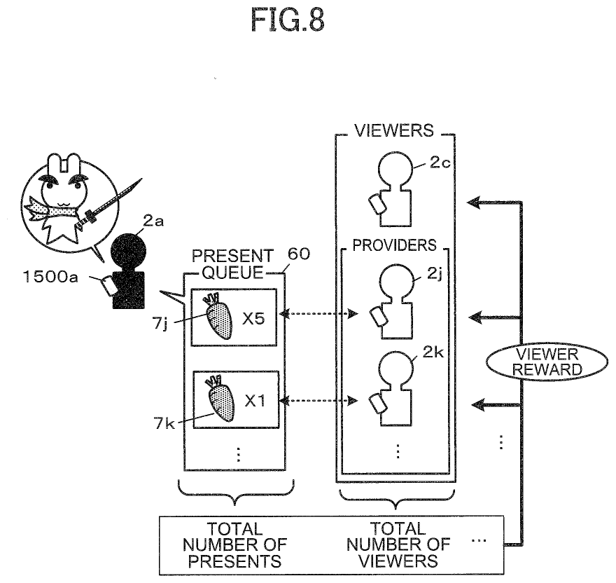

FIG. 8 is a diagram illustrating giving an additional reward to a viewer when a viewer provides a present to a player. In the present embodiment, the reward is given to the present provider used by the player as described above. The reward is also given to the viewer (the users 2c, 2j, 2k, . . . in FIG. 8) other than the present provider when a predetermined reward giving condition is satisfied. The additional reward as a second additional reward is referred to as a “viewer reward”.

The content of the “viewer reward” may be set as appropriate. For example, the reward can be considered in the same manner as the reward for the present provider who provided the present used by the player.

The target of the viewer reward may be all viewers or may be limited to viewers who provided the same type of item as the present item that is used by the player.

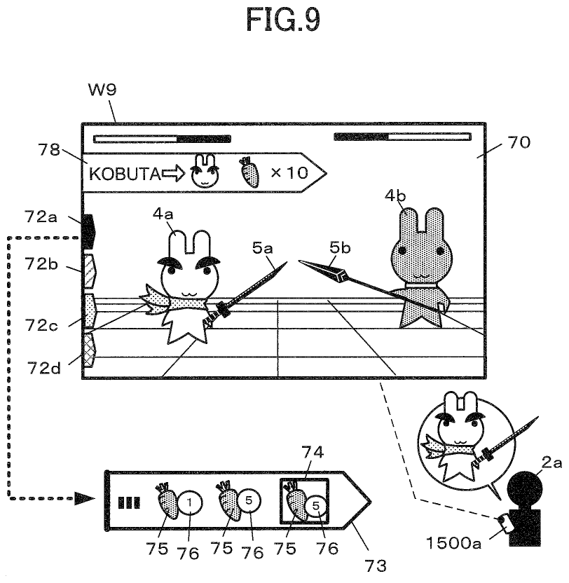

FIG. 9 is a diagram illustrating an example of a play screen W9 displayed on a user terminal 1500 (player terminal) for a player. The play screen W9 includes a gameplay screen 70, a plurality of present queue display tags 72 (72a, 72b, . . . ) corresponding to the item category, and a present generation notification 78.

The gameplay screen 70 is a play screen for the player. In the present embodiment, the content of the gameplay screen is the same as the content of the watching screen W3 (see FIG. 3). However, a game space viewed from a dedicated point-of-view of the player may be displayed depending on the details of the game.

The present queue display tag 72 is prepared corresponding to each of the present queue classified by the category of the items. A present selection window 73 showing the content of the corresponding present queue 60 (see FIG. 4) classified by the category of the items can be displayed by a touching operation (or a predetermined operation to the button switch 1504 (see FIG. 2) corresponding to each tag).

The present selection window 73 arranges and displays the present package that is registered to the corresponding present queue 60 according to the queue rank. Specifically, an item image 75 of the present to be given and an unused remaining number 76 in the package are displayed by package in association with each other. The present of the package at the top of the queue rank is displayed in a usable item frame 74 by default. The package quantity that can be displayed in the present selection window 73 is limited. Thus, a predetermined operation allows the package that is arranged according to the queue rank to be displayed by scrolling.

A present use operation by the player can be configured such that, for example, the player 1) operates the present queue display tag 72 to display the present selection window 73, 2) scrolls the arranged package to display and select a package located in the usable item frame 74, and 3) performs confirmation operation (for example, by double clicking inside the usable item frame 74) for the present displayed in the predetermined usable item frame 74, or the like.

When the player performs the present use operation, the present displayed in the usable item frame 74 is selected and used by the player. Every time the use operation is performed, the items in the package may be used one by one. The unused remaining number 76 is also updated every time the package is used. When all the presented items displayed with the unused remaining number 76 are used, the package reaches use completion, and the present listed at the next queue rank move up to the usable item frame 74.

The present generation notification 78 is a display having the same objective as the present generation notification 22 on the watching screen W3 (see FIG. 3). When giving a present occurs, the present generation notification 78 is displayed for a certain period of time, and then is deleted. The present generation notification 78 is displayed on the play screen W9 of the player terminal of the player who received the present. Further, the same content may be displayed on the play screen of the player terminal of another player who did not receive.

[Functional Configuration]

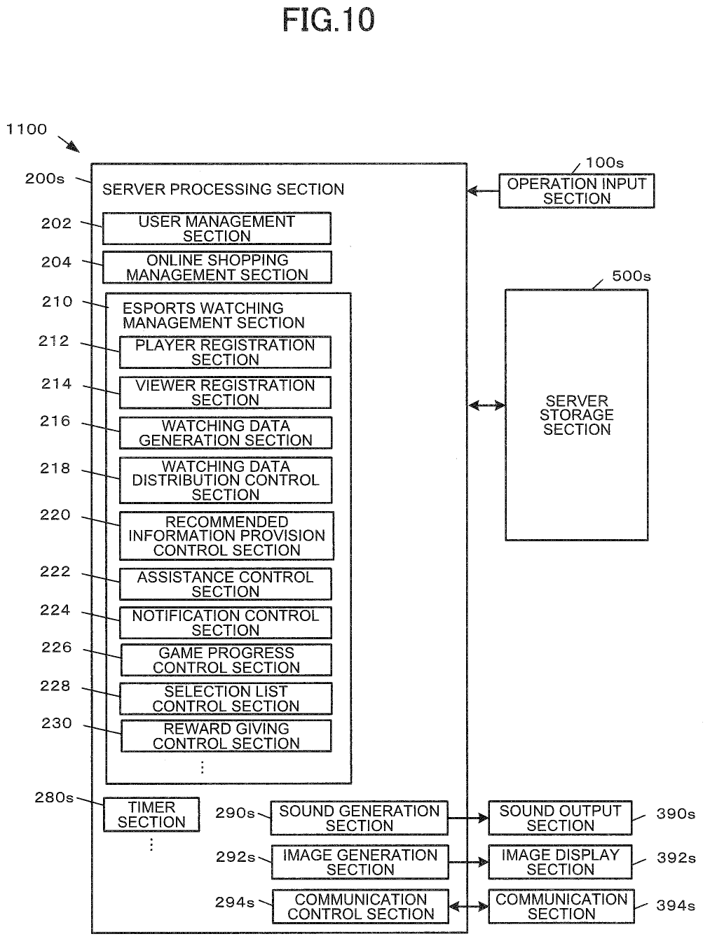

FIG. 10 is a functional block diagram illustrating an example of a functional configuration of the server system 1100 according to the present embodiment. The server system 1100 according to the present embodiment includes an operation input section 100s, a server processing section 200s, a sound output section 390s, an image display section 392s, a communication section 394s, and a server storage section 500s.

The operation input section 100s is for inputting various operations for server management. The operation input section 100s corresponds to the keyboard 1106 in FIG. 1.

The server processing section 200s is implemented with electronic parts such as a microprocessor (e.g., a CPU and a GPU), an ASIC, and an IC memory. The server processing section 200s controls data exchanged between functional sections including the operation input section 100s and the server storage section 500s. The server processing section 200s corresponds to the control boards 1150 of the game server 1101 and the distribution server 1102 in the example illustrated in FIG. 1.

The server processing section 200s performs various calculation processes based on a predetermined program, data, the operation input signal from the operation input section 100s, and data revived from the user terminal 1500 to entirely control the operation of the server system 1100.

The server processing section 200s according to the present embodiment includes a user management section 202, an online shopping management section 204, an esports watching management section 210, a timer section 280s, a sound generation section 290s, an image generation section 292s, and a communication control section 294s. Note that functional sections other than these may be included as appropriate.

The user management section 202 performs a process related to a user registration procedure and manages the data of each user associated with a user account. In the present embodiment, the user management section 202 has various functions including: 1) issuing a unique user account to a registered user; 2) registration information management for registering and managing personal information for each user account; 3) book keeping management for an electronic payment medium consumed for paying for a charged element (online shopping and play cost in the present embodiment); and 4) play history management for managing an inquiry request history. Note that any other appropriate management function for other data associated with the account can be included.

The online shopping management section 204 is in charge of control related to the online shopping, and can be implemented with a known online shopping technique as appropriate. In the present embodiment, the player can purchase items to be used in the game and the like through online shopping. Any other elements may be set as appropriate to be sold in the online shopping.

The esports watching management section 210 performs various controls related to esports watching. Specifically, the esports watching management section 210 includes a player registration section 212, a viewer registration section 214, a watching data generation section 216, a watching data distribution control section 218, a recommended information provision control section 220, an assistance control section 222, a notification control section 224, a game progress control section 226, a selection list control section 228, and a reward giving control section 230.

The player registration section 212 performs registration of the player user among the registered users. Specifically, when a predetermined player registration operation is input from the user terminal 1500, the user who uses the terminal is registered as a player.

The viewer registration section 214 performs registration of the viewer user among the registered users. Specifically, when a predetermined viewer registration operation is input from the user terminal 1500, the user who uses the terminal is registered as a viewer.

The watching data generation section 216 generates data for implementing esports watching, that is, the watching data on the user terminal 1500 used by the viewer (viewer terminal). In the present embodiment, this corresponds to a data preparation process for displaying the watching screen W3 (see FIG. 3).

The watching data distribution control section 218 controls distribution of the generated distribution data to the user terminal 1500 used by the viewer (viewer terminal).

The recommended information provision control section 220 controls provision of recommended information to the viewer terminal based on the progress of the game that is a target of esports watching. The recommended information includes information on an assistance object that will be advantageous for the progress of the game when used by the player. More specifically, this corresponds to display control for a recommended information display 31 in the present operation section 30.

The assistance control section 222 accepts assistance instruction of assisting the player by giving an object from a viewer via the viewer terminal, and controls giving of a single object or a plurality of objects (assistance objects) for assisting the player. More specifically, this corresponds to control of giving the item 5 as a present.

Specifically, the assistance control section 222 performs control of selecting the assistance object among possessed objects of the viewer according to the selection operation instruction by the viewer and giving the assistance object to the player. The assistance control section 222 can perform control of giving an assistance object according to purchase operation instruction. In the instruction, the viewer purchases the assistance object to be given to the player. More specifically, this corresponds to execution of giving a present according to operation of the possessed item present execution operation icon 35 or the spot purchase and present execution operation icon 37 that is associated with the item displayed in the recommended information display 31 of the present operation section 30.

When present provision is performed, the assistance control section 222 accepts assistance instruction and give the assistance object to the player. The assistance instruction can be performed as a whole in one operation or automatically used intermittently or continuously with a package as a unit.

The notification control section 224 controls notification to the player terminal of the player every time an assistance object is given to the player. More specifically, this corresponds to the present generation notification 78 (see FIG. 9).

The game progress control section 226 performs various processes related to gameplay management. The game according to the present embodiment is a client-server online game, and thus the game progress control section 226 according to the present embodiment communicates with the user terminal 1500 to perform control for providing data required for the gameplay.

The game progress control section 226 controls the progress of the game by using the assistance object based on the use operation of the player for esports watching. At that time, the progress of the game can be controlled by changing exerted effects according to the timing at which the used assistance object is given.

The selection list control section 228 variably controls the display rank of the assistance object that is displayed in the selection list when the player selects the assistance object for use in the game. Specifically, the display rank is variably controlled according to the content of the package of the assistance object with a package as a unit. More specifically, this corresponds to control of the arrangement display of the present in the present selection window 73 of the play screen W9 (see FIG. 9) based on the queue rank registered in the present queue 60.

Further, the selection list control section 228 can variably control the display rank according to whether the relationship between the viewer who gave the assistance object and the player is a predetermined relationship, and according to intimacy between the viewer who gave the assistance object and the player.

The reward giving control section 230 controls provision of reward to the viewer who gave the assistance object and/or to the player based on whether the assistance object is used or not used by the player. More specifically, this corresponds to the control of giving a provider reward, a player reward, and a viewer reward. The viewer reward is given only to the viewer who gave the same assistance object as the assistance object used in the gameplay that is the target of the esports watching.

When the assistance object is used, the reward giving control section 230 can change the content of the reward based on 1) the timing that the assistance object is given to the player, 2) the quantity of given (simultaneously provided) assistance objects, 3) the game result of the target gameplay for esports watching, and 4) the type and/or quantity of the assistance object used in the target gameplay for esports watching, or the like.

The reward giving control section 230 may give the provider reward as a reward of increasing intimacy between the viewer who gave the assistance object and the player when the assistance object is used.

The timer section 280s uses a system clock to obtain the current date and time, a limited time period, and the like.

The sound generation section 290s is implemented with an integrated circuit (IC) or by executing software that generates sound data and performs decoding, and generates or decodes sound data on operation sound and background music (BGM) related to system management for the server system 1100 and the gameplay. The resultant sound signal related to the system management is output to the sound output section 390s.

The sound output section 390s receives the sound signal to emit the corresponding sound. The sound output section 390s corresponds to a speaker (not illustrated) of the game server 1101 or the touch panel 1108 in the example illustrated in FIG. 1.

The image generation section 292s can generate an image related to the system management for the server system 1100, a game image (or data for displaying the game image on the user terminal 1500), and the like. The image related to the system management can be output to the image display section 392s.

The image display section 392s displays various images for system management based on the image signals input from the image generation section 292s. The image display section 392s can be implemented with an image display device, such as a flat panel display, a cathode ray tube (CRT), a projector, or a head-mounted display. The image display section 392s corresponds to the touch panel 1108 in the example illustrated in FIG. 1.

The communication control section 294s performs a data process related to the data communication, and exchanges data with an external device through the communication section 394s.

The communication section 394s connects to the communication line 9 to implement communications. The communication section 394s is implemented with a transceiver, a modem, a terminal adapter (TA), a jack for a communication cable, a control circuit, and the like. The communication section 394s corresponds to the communication device 1153 in the example illustrated in FIG. 1.

The server storage section 500s stores a program and various types of data for implementing various functions of the server processing section 200s for entirely controlling the server system 1100. The server storage section 500s is used as a work area for the server processing section 200s, and temporarily stores the results of calculations performed by the server processing section 200s based on various programs. The functions of the server storage section 500s are implemented with an IC memory (e.g., RAM and ROM), a magnetic disk (e.g., hard disk), an optical disk (e.g., CD-ROM and DVD), an online storage, or the like. The server storage section 500s corresponds to a storage medium, such as the IC memory and hard disk of the control board mounted in the game server 1101 and the distribution server 1102, and the storage 1140 in the example illustrated in FIG. 1.

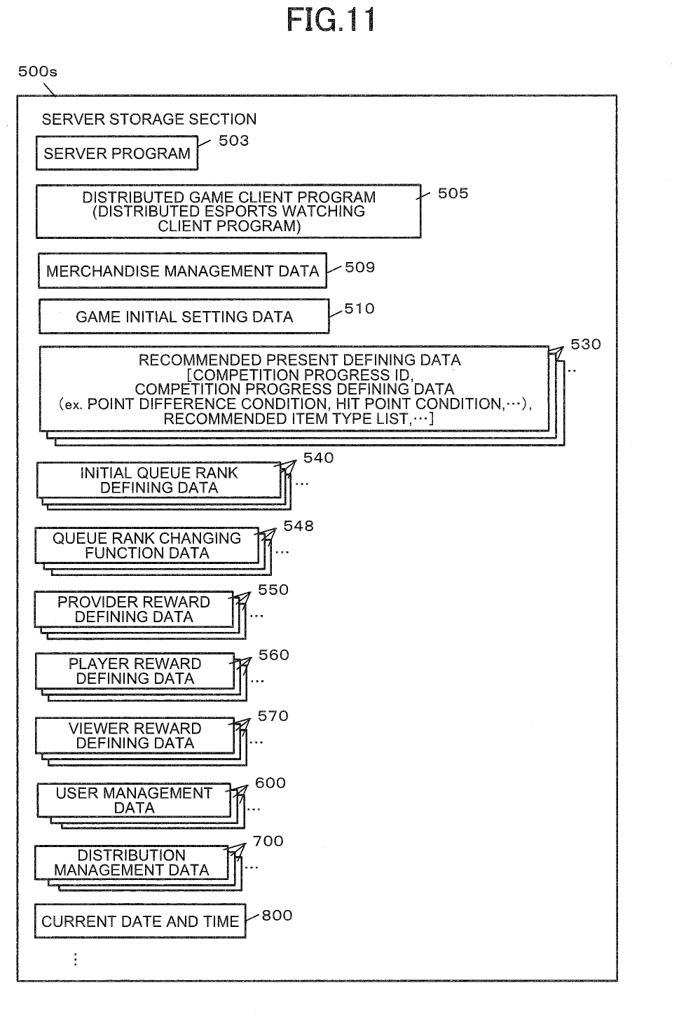

FIG. 11 is a diagram illustrating an example of programs and data stored in the server storage section 500s according to the present embodiment.

The server storage section 500s according to the present embodiment stores therein a server program 503, a distributed game client program 505, merchandise management data 509, game initial setting data 510, recommended present defining data 530, initial queue rank defining data 540 (see FIG. 6), queue rank changing function data 548 (see FIG. 6), provider reward defining data 550, player reward defining data 560, and a viewer reward defining data 570.

The server storage section 500s stores data, sequentially generated and managed, including user management data 600, distribution management data 700, and current date and time 800. Furthermore, the server storage section 500s can store information on a timer, a counter, various flags, and the like as appropriate.

The server program 503 is read out and executed by the server processing section 200s for implementing functions of the user management section 202, the online shopping management section 204, and the esports watching management section 210 (see FIG. 10).

The distributed game client program 505 is an original of a game client program provided for the user terminal 1500. In the present embodiment, esports watching is implemented by a function of the game client. Thus, the program can be regarded as a program including “a distributed esports watching client program”.

The merchandise management data 509 includes data for defining and managing selling products of online shopping. For example, purchasable items, stock quantities, and charge prices (equivalent to debit amounts from payment media in the present embodiment) are stored in association with one another. In the present embodiment, the merchandise includes the player character 4 (4a, 4b, . . . ) and the items 5 (5a, 5b, . . . ) (see FIG. 3).

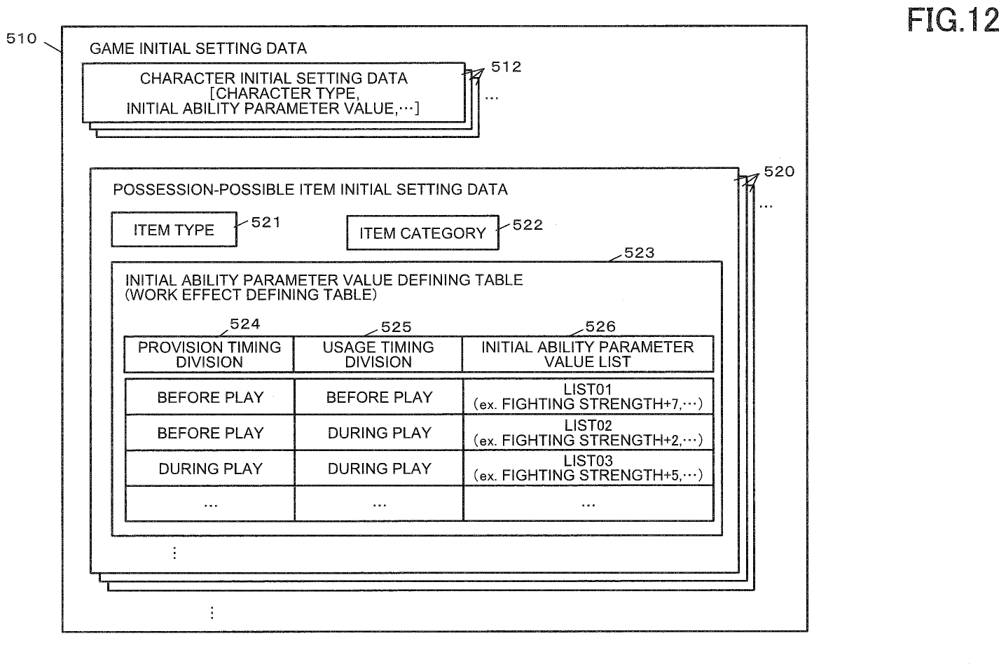

The game initial setting data 510 includes various kinds of initial setting data for implementing an online game as a base of the esports watching. In the present embodiment, as illustrated in FIG. 12, this includes character initial setting data 512 for each type of character that appears in the game and possession-possible item initial setting data 520. Note that data other than these can be included as appropriate.

The possession-possible item initial setting data 520 is prepared for each type of the items 5 that can be possessed by the user 2, that is, for each type of the item 5 that can be presented. Each of the possession-possible item initial setting data 520 includes an item type 521 that shows the destination of the setting data, an item category 522, and an initial ability parameter value defining table 523. Note that data other than these can be included as appropriate.

The initial ability parameter value defining table 523 includes a division of timing of giving an item (a provision timing division 524), a division of timing of using the item (a usage timing division 525), and an initial ability parameter value list 526 that defines an ability of the type of the item, that is, a work effect applicable to the item when the item is used, in association with each other. In the present embodiment, both the provision timing division 524 and the usage timing division 525 are divided into two divisions of before and during the play, however, the number of division types may be set as appropriate. For example, the usage timing division 525 may be divided into multiple divisions according to the time lapse from the start of the play. Further, the division can be set based on the event that occurs in the game such that a predetermined time period is set just after the player character 4 of the player who is the destination of the present suffered damage or the time period is set after the player character 4 of the player succeeded in a combo.

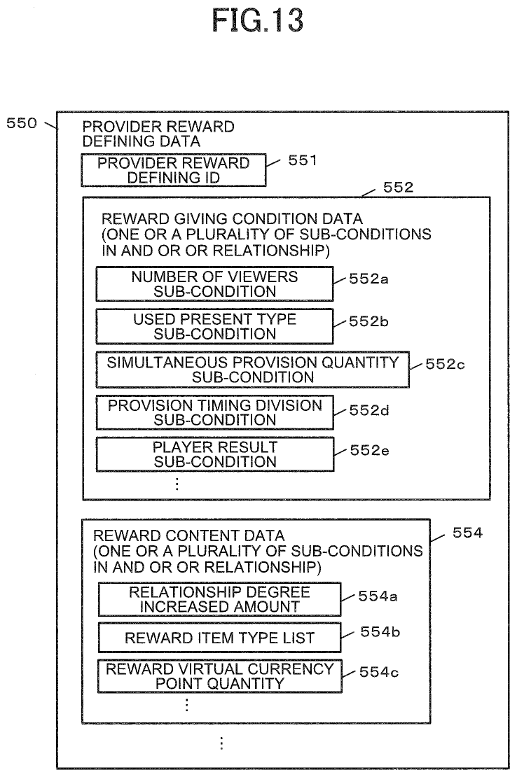

Referring back to FIG. 11, the provider reward defining data 550 defines the provider reward (see FIG. 4), and includes various types of data for defining a condition for giving the provider reward (reward giving condition) and what type of reward will be given. As illustrated in FIG. 13, for example, each of the provider reward defining data 550 includes a unique provider reward defining ID 551, reward giving condition data 552, and reward content data 554. Note that data other than these can be included as appropriate.

The reward giving condition data 552 is indicated by one or a plurality of sub-conditions in AND or OR relationship. The sub-conditions may be set as appropriate. In the present embodiment, the sub-conditions include:

1) a viewer sub-condition 552a that defines a requirement related to the number of viewers;

2) a used present type sub-condition 552b that is a requirement related to the type of the used present;

3) a simultaneous provision quantity sub-condition 552c that is a requirement related to the simultaneously provided quantity when the used present was provided;

4) a provision timing division sub-condition 552d that is a requirement related to the provision timing division when the used present was provided (in the present embodiment, one or both of before the play and during the play); and

5) a player result sub-condition 552e that is a requirement related to a play result of the player who used the present (for example, content of the game including a competition result, an acquired point, a race time, etc. that may be set as appropriate). Note that each of the sub-conditions can be set as “no setting”. Also, the sub-conditions to be adopted are not limited to these and may be omitted or other content of sub-conditions may be adopted as appropriate.

The reward content data 554 defines a reward that is given to a user who is the provider of the used present. For example, a single type or a plurality of types, such as a relationship degree increased amount 554a that changes a relationship degree setting value set between the player who used the present and the provider, a reward item type list 554b that defines the types and quantity of the reward item to be given, and a reward virtual currency point quantity 554c that defines the quantity of virtual currency points to be given, may be set. Note that reward contents other than these can be set as appropriate.

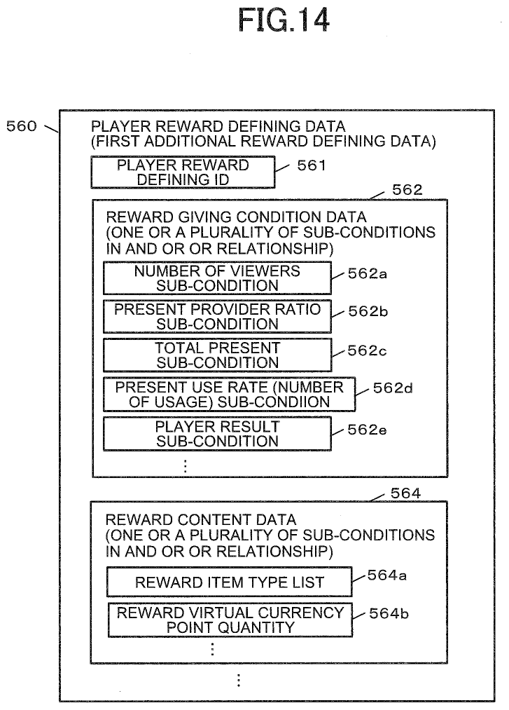

Referring back to FIG. 11, the player reward defining data 560 defines the player reward (see FIG. 7), and includes various types of data for defining a condition for giving the player reward (reward giving condition) and what type of reward will be given. As illustrated in FIG. 14, for example, each of the player reward defining data 560 includes a unique player reward defining ID 561, reward giving condition data 562, and reward content data 564. Note that data other than these can be included as appropriate.

The reward giving condition data 562 is indicated by one or a plurality of sub-conditions in AND or OR relationship. The sub-conditions may be set as appropriate. In the present embodiment, the sub-conditions include:

1) a number of viewers sub-condition 562a that defines a requirement related to the number of viewers;

2) a present provider ratio sub-condition 562b that is a requirement related to a ratio of the viewer who provided the present to the number of all viewers;

3) a total present sub-condition 562c that is a requirement related to the total number of presents;

4) a present use rate sub-condition 562d that is a requirement related to the ratio (or number) of the actually used present to the provided present; and

5) a player result sub-condition 562e that defines a requirement related to the play result of the player who used the present.

Note that each of the sub-conditions can be set as “no setting”. Also, the sub-conditions to be adopted are not limited to these and may be omitted or other content of sub-conditions may be adopted as appropriate.

The reward content data 564 defines a reward that is given to a user who is the provider of the used present. For example, a single type or a plurality of types, such as a reward item type list 564a that defines the types and quantity of the reward item to be given, and a reward virtual currency point quantity 564b that defines the quantity of virtual currency points to be given, may be set. Note that reward contents other than these can be set as appropriate.

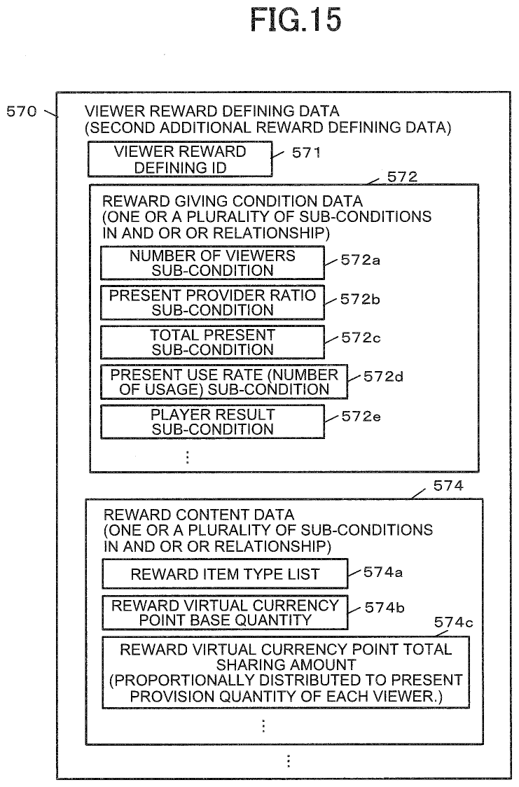

Referring back to FIG. 11, the viewer reward defining data 570 defines the viewer reward (see FIG. 8), and includes various types of data for defining a condition for giving the viewer reward (reward giving condition) and what type of reward will be given. As illustrated in FIG. 15, for example, each of the viewer reward defining data 570 includes a unique viewer reward defining ID 571, reward giving condition data 572, and reward content data 574. Note that data other than these can be included as appropriate.

The reward giving condition data 572 is indicated by one or a plurality of sub-conditions in AND or OR relationship. The sub-conditions may be set as appropriate. In the present embodiment, the sub-conditions include 1) a number of viewers sub-condition 572a, 2) a present provider ratio sub-condition 572b, 3) a total present sub-condition 572c, 4) a present use rate sub-condition 572d, and 5) a player result sub-condition 572e. Note that each of the sub-conditions can be set as “no setting”. Also, the sub-conditions to be adopted are not limited to these and may be omitted or other content of sub-conditions may be adopted as appropriate.

The reward content data 574 defines a viewer reward. For example, a single type or a plurality of types, such as a reward item type list 574a that defines the type and the quantity of the given reward item, a reward virtual currency point base quantity 574b that defines the least giving quantity of the virtual currency points, and a reward virtual currency point total sharing amount 574c that defines the quantity of virtual currency points to be shared by all viewers, may be set. Note that reward contents other than these can be set as appropriate.

The reward virtual currency point total sharing amount 574c may be shared in a manner as appropriate. The manner includes random sharing in which different distribution rate is applied for each viewer, proportional sharing according to the total number of presents the viewer has provided, or the like. In the present embodiment, proportional sharing is used.

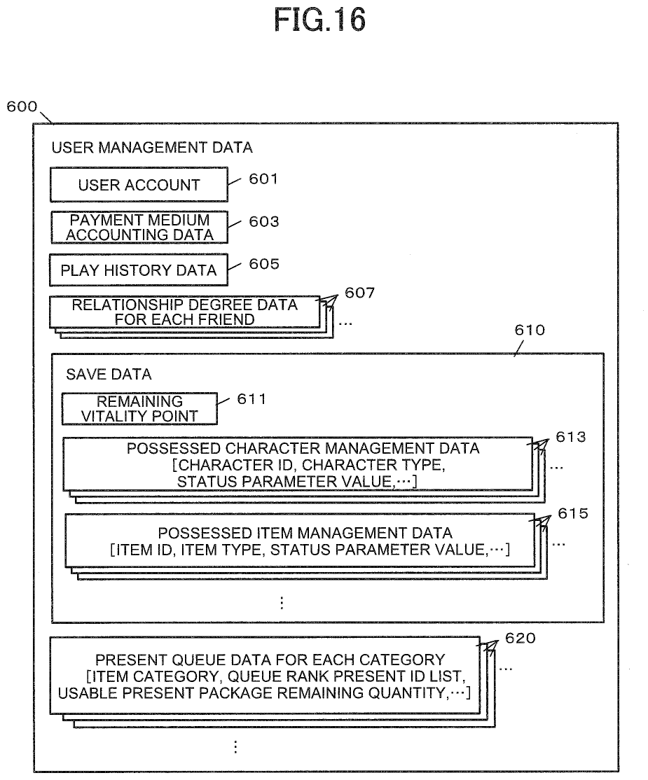

Referring back to FIG. 11, the user management data 600 is prepared for each registered user, and includes various types of data associated with a unique identification information, namely, an account. As illustrated in FIG. 16, for example, each of the user management data 600 includes a unique user account 601 that has been set at the time of user registration, payment medium accounting data 603, play history data 605, relationship degree data 607 for each friend, save data 610, and present queue data 620 for each category. Note that data other than these can be included as appropriate.

The payment medium accounting data 603 serves as what is known as an account book storing therein information on a charged/consumed amount (of specified parameter values, such as virtual currency points, game currency, specified items, or vitality) of the payment medium for electronic payment associated with the user, information on a reason for the charging/consumption, and information on changed date and time in association with one another. The payment medium accounting data 603 can also be referred to as charge history data or charge information.

The play history data 605 is data in which the past game played timings are stored in time series, and is automatically updated at a log-in/log-out timing. An operation input log as to what operation input has been performed may be included as appropriate.

The relationship degree data 607 for each friend is prepared for each “friend” who is a user certified and registered as a friend by the other user. Each of the user account that is registered as a friend and the parameter value of the relationship degree are associated in the data.

The save data 610 includes various types of data indicating the game progress state played by the user at the previous gameplay. For example, this includes: 1) a remaining vitality point 611 that stores a remaining vitality point to be consumed according to the time and content of gameplay of the user; 2) a possessed character management data 613 that describes the status of each possessed character at the timing of data saving; and 3) a possessed item management data 615 that describes the status of each possessed items at the timing of data saving. Note that data other than these can be included as appropriate.

The present queue data 620 for each category is generated for esports watching when the user is a player, and defines the present queue 60 (see FIG. 4) of the present given to the user as a destination.

Each of the present queue data 620 for each category includes, for example, an item category, a queue rank present ID list in which the present ID is arranged by the queue rank, and a usable present package remaining quantity that is a remaining number of the present in the top queue rank at that timing. Note that data other than these can be included as appropriate.

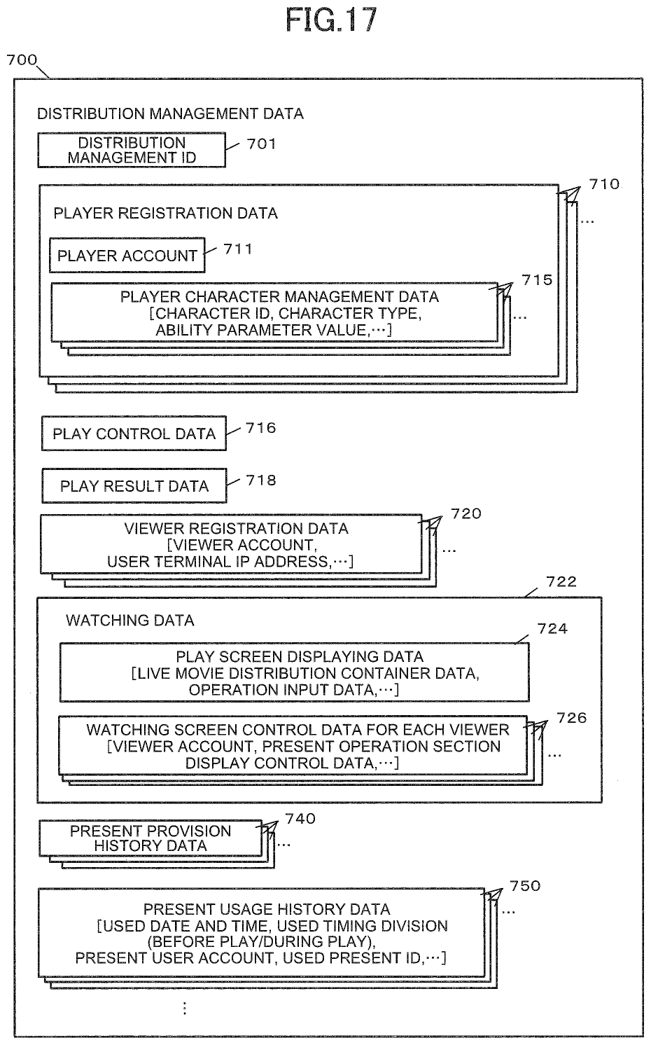

Referring back to FIG. 11, the distribution management data 700 is prepared for each distributed program of esports watching and includes various types of data associated with the distribution management. As illustrated in FIG. 17, for example, each of the distribution management data 700 includes a unique distribution management ID 701, player registration data 710, play control data 716, play result data 718, viewer registration data 720, watching data 722, present provision history data 740, and present usage history data 750. Note that data other than these can be included as appropriate.

The player registration data 710 is prepared for each player. Each of the player registration data 710 includes a player account 711 which is a user account of a user as a player, and player character management data 715 that is a setting data at the time of starting the play by the player character 4 of the player. Note that data other than these can be included as appropriate.

The play control data 716 includes various types of data describing a gameplay situation of the game. In the present embodiment, examples include the latest situation (e.g., a list of ability parameter values of hit points and fighting strength, information of status abnormality such as a paralyzed state, and the number of attack combos) of the player character 4 of each player, and a remaining period of the game. Note that information other than these may be included as appropriate.

The viewer registration data 720 is prepared for each user registered as a viewer, and includes information to identify the user (e.g., a viewer account, which is a user account of the user as a viewer), and information for communicating with the user terminal 1500 used by the user.

The watching data 722 is data for displaying the watching screen W3 (see FIG. 3) to implement esports watching to the user terminal 1500 of a viewer. In the present embodiment, the watching data 722 includes play screen displaying data 724, and watching screen control data 726 for each viewer.

The play screen displaying data 724 is for implementing the play screen display section 20 that displays the situation of the play on the watching screen W3 (see FIG. 3) of the user terminal 1500. Details of the data can be set as appropriate in accordance with a method for implementing the esports watching. In adopting a live streaming distribution method, for example, the gameplay image display section data 724 corresponds to container data. In rendering the progress of the game displayed in the play screen display section 20 on the user terminal 1500, the play screen displaying data 724 corresponds to operation input data indicating details of operation input by each player.

The watching screen control data 726 for each viewer is prepared for each viewer, and includes various types of data for individual control of the contents of the display of the watching screen W3 (see FIG. 3). Each of the watching screen control data 726 for each viewer corresponds with the viewer account, and can include display data of the present operation section 30, the present generation notification 22, the present stock display section 24, the present detail setting screen W4, and the shopping screen W5.

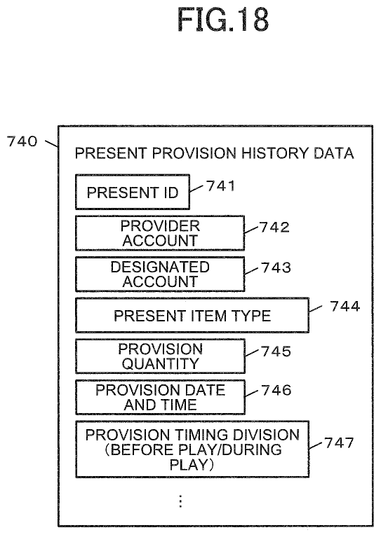

The present provision history data 740 is generated according to the present execution operation, and includes various types of data that defines the content of the implemented present. As illustrated in FIG. 18, for example, each of the present provision history data 740 includes a unique present ID 741, a provider account 742 that designates the viewer who has provided the present, a designated account 743 that designates the player who has received the present, a present item type 744 and a provision quantity 745 of the present package, provision date and time 746, and a provision timing division 747. Note that data other than these can be included as appropriate.

Referring back to FIG. 17, the present usage history data 750 is generated according to the present use operation, and includes various types of data associated with who and at which timing the present has been used. Specifically, used date and time, a used timing division, a present user account of a player who has used the present, and a used present ID are included. Note that data other than these can be included as appropriate.

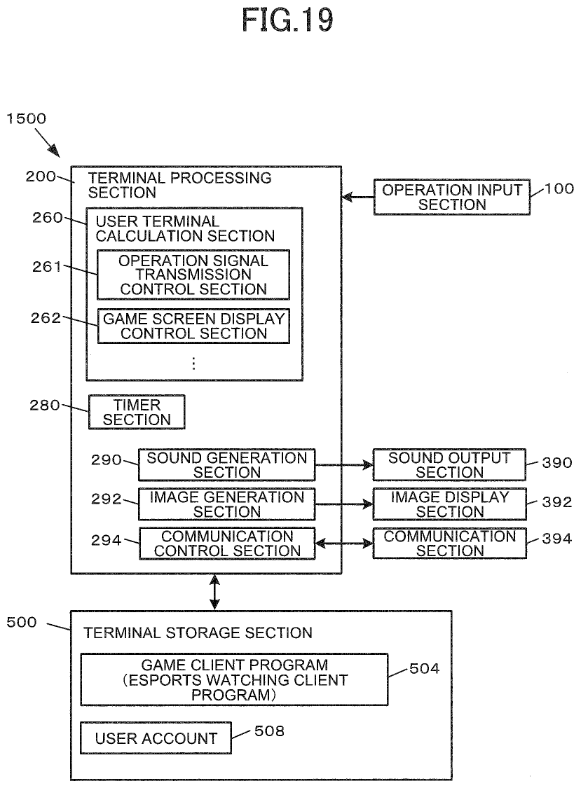

FIG. 19 is a functional block diagram illustrating an example of a functional configuration of the user terminal 1500 according to the present embodiment. The user terminal 1500 according to the present embodiment includes an operation input section 100, a terminal processing section 200, a sound output section 390, an image display section 392, a communication section 394, and a terminal storage section 500.

The operation input section 100 outputs an operation input signal, based on various operations input by the player, to the terminal processing section 200. The operation input section 100 can be implemented with a push switch, a joystick, a touch pad, a track ball, an accelerometer, a gyro, a CCD module, or the like. The operation input section 100 corresponds to the arrow key 1502, the button switch 1504, and the touch panel 1506 in FIG. 2.

The terminal processing section 200 is implemented with electronic parts, such as a microprocessor (e.g., CPU and GPU), an ASIC, and an IC memory. The terminal processing section 200 performs input/output control to exchange data with each of the functional sections including the operation input section 100 and the terminal storage section 500. The terminal processing section 200 executes various calculation processes based on a predetermined program or data, the operation input signal from the operation input section 100, and various types of data received from the server system 1100 to control the operation of the user terminal 1500. The terminal processing section 200 corresponds to the control board 1550 in FIG. 2. The terminal processing section 200 according to the present embodiment includes a user terminal calculation section 260, a timer section 280, a sound generation section 290, an image generation section 292, and a communication control section 294.

The user terminal calculation section 260 includes an operation signal transmission control section 261, and a game screen display control section 262.

The operation signal transmission control section 261 performs a process of transmitting various types of data and a request to the server system 1100 in accordance with an operation on the operation input section 100.

The game screen display control section 262 performs, based on various types of data received from the server system 1100, a control for displaying the gameplay screen when the user plays the game using an own device (including when the user of the own device is the player), and a control for displaying the watching screen W3 (see FIG. 3) for watching esports using the own device. In the present embodiment, the server system 1100 generates the image that is displayed on the play screen display section 20 (see FIG. 3) or the gameplay screen 70 (see FIG. 9) (for example, a 3DCG image or the like). Alternatively, a configuration where the user terminal 1500 generates the image may also be employed. In this case, the game screen display control section 262 is in charge of controlling an object disposed in a virtual three-dimensional space for generating a 3DCG for example.

The sound generation section 290 is implemented with a processor, such as a DSP or a sound synthesizing IC, an audio codec capable of reproducing a sound file, or the like. Based on a processing result by the game screen display control section 262, the sound generation section 290 generates a sound signal for sound effects, a BGM, various operation sounds, and the like related to the game, and outputs the sound signal thus generated to the sound output section 390

The sound output section 390 is implemented with a device that outputs sound such as sound effects or BGM, based on the sound signal received from the sound generation section 290. The sound output section 390 corresponds to the speaker 1510 in FIG. 2.

The image generation section 292 is implemented, for example, with a processor (e.g., a GPU or a DSP), a video signal IC, a program (e.g., video codec), a drawing frame IC memory (e.g., frame buffer), and the like.

The image generation section 292 generates an image of one game screen in every frame (e.g., 1/60th of a second) based on the various types of data received from the server system 1100, and outputs the generated image signal of the game screen to the image display section 392.

The image display section 392 displays various game images based on the image signals input from the image generation section 292. The image display section 392 can be implemented with an image display device, such as a flat panel display, a cathode ray tube (CRT), a projector, or a head-mounted display. In the present embodiment, the image display section 392 corresponds to the touch panel 1506 illustrated in FIG. 2.

The communication control section 294 performs a data process for data communications, and exchanges data with an external device through the communication section 394. The communication section 394 connects to the communication line 9 to implement communications. For example, the communication section 394 is implemented with a transceiver, a modem, a TA, a jack for a communication cable, a control circuit, and the like, and corresponds to the wireless communication module 1553 in FIG. 2.

The terminal storage section 500 stores therein a program for implementing various functions for causing the terminal processing section 200 to entirely control the user terminal 1500, various types of data, and the like. The terminal storage section 200 is used as a work area for the terminal processing section 200, and temporarily stores a result of calculation performed by the terminal processing section 200 in accordance with various programs, input data received from the operation input section 100, and the like. These functions are implemented with an IC memory (e.g., RAM and ROM), a magnetic disk (e.g., hard disk), an optical disk (e.g., CD-ROM and DVD), or the like. The terminal storage section 500 corresponds to the IC memory 1552 and the memory card 1540 in the control board 1550 illustrated in FIG. 2.

The terminal storage section 500 according to the present embodiment stores therein a game client program 504, and a user account 508 indicating a user equipped with his/her own terminal that has been input at the time of log-in. Note that programs and data other than these can be stored as appropriate.

The game client program 504 is an application software that implements a function of the user terminal calculation section 260 when read and executed by the terminal processing section 200. In the present embodiment, the game client program 504 is a copy of the distributed game client program 505 (see FIG. 11) provided from the server system 1100.

The game client program 504 may be an exclusive client program or include a web browser program and a plugin that implements an interactive image display, depending on a technique and a method for implementing an online game.

[Operations]

Next, a flow of a process in the server system 1100 will be described. The flow of the process described herein is implemented by the server processing section 200s executing the server program 503.

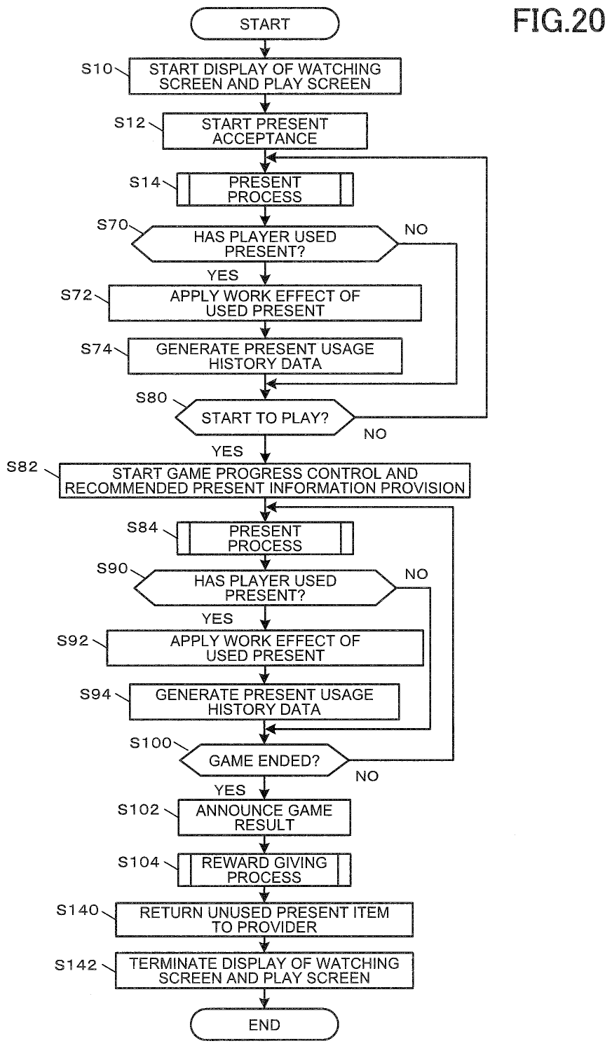

FIG. 20 is a flowchart illustrating a flow of a process in the server system 1100 according to the present embodiment.

Note that registration of the player and the viewer is regarded as completed. The registration of the player and the viewer can be implemented by the same methods as known esports watching methods.

In the present embodiment, the game client program 504 is being executed in the user terminal 1500 of the player. When a predetermined player registration operation is input after log-in, a user account and a predetermined player registration request are transmitted to the server system 1100. When the server system 1100 receives the request, the server system 1100 generates a player registration data 710 of the user of the user terminal 1500 (see. FIG. 17).

The game client program 504 is also being executed in the user terminal 1500 of the viewer. When a predetermined esports watching operation is input after log-in, a user account of the own device and a predetermined viewer registration request are transmitted to the server system 1100. When the server system 1100 receives the request, the server system 1100 generates a viewer registration data 720 of the user of the user terminal 1500 (see FIG. 17).

When a predetermined esports event timing is reached, the server system 1100 starts generating and distributing the watching data 722 (see FIG. 17) while the play, that is, the gameplay that is a target of the watching is not started, to start display of the play screen W9 on the player terminal and the watching screen W3 on the viewer terminal (step S10). Then, an acceptance of the present is started (step S12).

Next, the server system 1100 performs a present process (step S14).

The present process according to the present embodiment is a control of giving an assistance object from a viewer to a player (or a player team depending on the game).

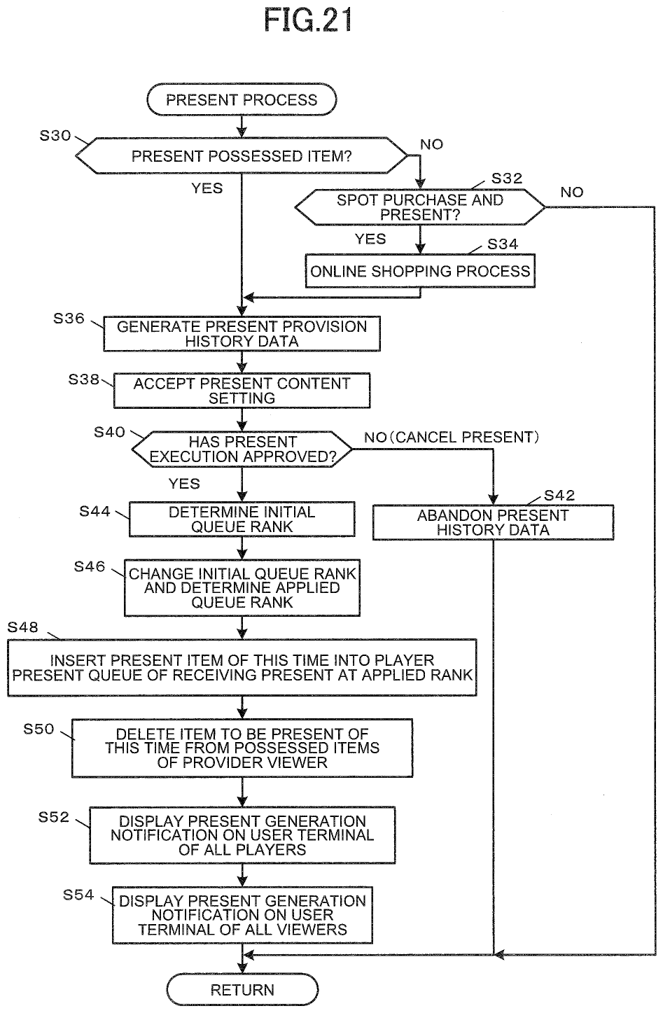

FIG. 21 is a flowchart illustrating a flow of a present process.

In that process, when the possessed item present execution operation icon 35 in the watching screen W3 (see FIG. 3) is operated on the viewer terminal, the server system 1100 judges that an assistance operation instruction for giving an item that is possessed by the viewer is issued (YES in step S30). Then, the present provision history data 740 is newly generated (see FIGS. 17 and 18) (step S36), and the present detail setting screen W4 is displayed on the viewer terminal to accept a detailed setting of the content of the present. Then, the result of setting operation is included in the present provision history data 740 (step S38).

When the spot purchase and present execution operation icon 37 on the watching screen W3 (see FIG. 3) is operated on the viewer terminal (Yes in step S32), the server system 1100 implements spot shopping of the present item by executing an online shopping process (step S34), generates the present provision history data 740 (step S36) and accepts the detailed setting of the content of the present (step S38).

When the cancellation operation icon 47 is operated in the present detail setting screen W4 (NO in step S40), the server system 1100 abandons the present provision history data 740 that has been generated in step S36 (step S42), and terminates the present process.

By contrast, when the confirmation operation icon 45 is operated in the present detail setting screen W4, the server system 1100 judges that the present execution is approved (YES in step S40), refers to the initial queue rank defining data 540 (see FIG. 6), and determines the initial queue rank for the present of this time (step S44). Next, by referring to the queue rank changing function data 548, the determined initial queue rank is corrected, and the applied queue rank is determined (step S46).

Then, a designated provision quantity of the item 5 to be the present of this time is regarded as one package, and the server system 1100 inserts the package into the present queue of the designated player such that the queue rank of the package becomes the applicable queue rank (step S48).

Specifically, in the present queue data 620 for each category of the user management data 600 of the designated player (see FIG. 16), the queue data that matches the item category of the present item at this time is searched. Then, the present ID of this time is inserted into the queue rank present ID list to become the applied queue rank. Then, based on the list after insert, the usable present package remaining number quantity is updated as appropriate.

Next, the server system 1100 deletes the item 5 to be the present of this time by the number of provisions from the possessed item of the viewer who has provided the item (step S50). Thus, giving of a present has been substantially completed.

Next, the server system 1100 causes the user terminal 1500 of all players (player terminal) to display the present generation notification 78 (see FIG. 9) (step S52). Note that the target of display of the present generation notification 78 can be limited to the user terminal 1500 of the player (player terminal) who receives the present at this time.

Then, the server system 1100 displays the present generation notification 22 (see FIG. 3) on the user terminal 1500 of all viewers (viewer terminal) (step S54), and terminates the present process.

Referring back to FIG. 20, when a use operation of the predetermined present is detected on the player terminal (YES in step S70), the work effect of the present to be used is determined and applied (step S72) with reference to the possession-possible item initial setting data 520 (see FIG. 12) that is applicable to the type of the present item to be used. Then, the present usage history data 750 (see FIG. 17) is generated, and the present queue data 620 for each category in which the used present has been registered (see FIG. 16) is updated (step S74).

The provision of the present by the viewer and the use of the present by the player before starting the play may be executed until the start of the play (NO in step S80).

When the scheduled starting timing of the play has come (YES in step S80), the server system 1100 starts control of the game process played by the player, and starts display control of recommended information display 31 on the watching screen W3 (see FIG. 3) based on the recommended present defining data 530 (see FIG. 11) (step S82). Subsequent to the above, in the present operation section 30, an item that may be more beneficial for the player depending on the situation of the play at each occasion is displayed at an upper rank. Corresponding to the order of display rank of the recommended information display 31, displays such as the possession status display 33, the possessed item present execution operation icon 35, or the spot purchase and present execution operation icon 37 are updated successively.

Next, the server system 1100 performs a present provision by a viewer during the play and a process for the player to use the present until the play is ended.

That is, the server system 1100 performs the present process (step S84), and stores the present use and the use history according to the present use operation input from the player terminal (steps S90 to S94).

When the game is ended (YES in step S100), the server system 1100 performs control for announcing a game result (step S102), and executes a reward giving process (step S104).

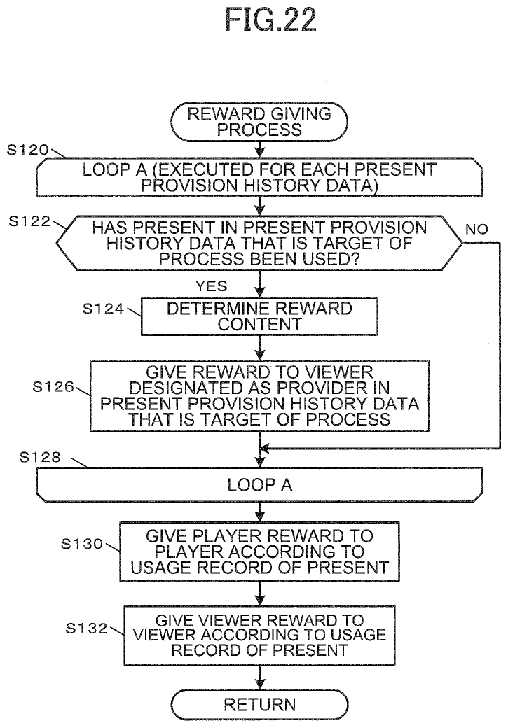

FIG. 22 is a flowchart illustrating a flow of a reward giving process. In the process, the server system 1100 executes a loop A for each present provision history data 740 (steps S120 to S128).

In the loop A, whether the present in the present provision history data 740 that is the target of the process has been used or not is judged (step S122). In the present embodiment, the present is managed in a form of a single item or a plurality of items in one package. Thus, in the above step, judgment may be positive when all items in the package are used, or judgment may be positive when at least one of the items in the package is used. In the present embodiment, judgment is positive when use of the whole package has been completed.

Next, when the judgment is positive (YES in step S122), the server system 1100 refers to the provider reward defining data 550 (see FIG. 13) to determine the content of the reward to be given (step S124), and gives the determined reward to the viewer who is designated by the provider account 742 in the present provision history data 740 that is the target of the process (step S126). In this process, a reward giving notification is preferably displayed on the viewer terminal of the viewer who has been given the reward as appropriate.

When the loop A is performed for all the present provision history data 740, the server system 1100 then refers to the present usage history data 750 (see FIG. 17) and the player reward defining data 560 (see FIG. 14) to give a player reward according to the usage record of the present (step S130). In this process, a reward giving notification is preferably performed on the terminal of the player who has been given the reward as appropriate.

Further, the server system 1100 refers to the present usage history data 750 (see FIG. 17) and the viewer reward defining data 570 (see FIG. 15) to give a viewer reward according to the use record of the present (step S132). In this process, a reward giving notification is preferably performed on the terminal of the viewer who has been given the reward as appropriate.

Then, the reward giving process is terminated.

Referring back to FIG. 20, the server system 1100 then returns the unused present item to the provider of the item (step S140). In the returning step, all unused items may be returned, or part of the unused items may be returned (for example, 80% of the items are returned while 20% are remained). Alternatively, the present item may be exchanged to other items such as a virtual currency point via a predetermined route and returned. Note that the configuration may not include returning such that the returning step is omitted.

Then, the server system 1100 terminates the display of the watching screen W3 (see FIG. 3) on the viewer terminal and the display of the play screen W9 (see FIG. 9) on the player terminal (step S142) to terminate a series of processes.

As described above, in the present embodiment, assistance (a present in the present embodiment) of a target player by a viewer can be performed before or during the play while esports watching is implemented. Accordingly, a sense of unity as if the viewer is playing with the player, and a pleasure of cheering up during watching the new esports can be provided.

Also, the viewer can feels satisfied by giving an assistance to the player since the viewer possibly receives a provider reward or a viewer reward by giving assistance.

Further, as the limit of use of the present item is adopted by using a present queue, the rank set in the present queue can be increased according to the setting of the content of assistance (the content of the present in the present embodiment), and the present of one viewer may have a higher possibility of use by the player than the other present provider at an early stage. Thus, the setting of the content of assistance itself has an element of competition with other viewers. This can add a different taste of assistance to a player than merely a cheer.

[Modifications]

The embodiment that has been described above should not be construed in a limiting sense. Various modifications may be made as appropriate, such as adding other elements, omitting some of the elements, or changing some of the elements.

[First Modification]

For example, in the above-described embodiment, as the base of the esports watching, an online game is implemented with a client-server computer system. However, the online game may be implemented with a computer system in which a plurality of user terminals 1500 can establish a peer-to-peer connection. In that case, some of the user terminals 1500 may be made to implement the functions as the server system 1100 in the first embodiment. Alternatively, the plurality of user terminals 1500 may cooperate to implement the functions of the game progress control section 226.

[Second Modification]

In the above-described embodiment, watching data regarding the esports watching is centrally distributed with the client-server network system. However, the watching data may be distributed with a P2P network system.

[Third Modification]

In the above-described embodiment, content of the game as the base of the esports watching is a fighting competition game, for example. However, game genres and play modes as the base are not limited to this but may be set as appropriate. Examples may include a puzzle game of competing for time to complete a puzzle, a real-time strategy simulation game or shooting game played by a plurality of players divided into teams to compete against each other, a racing game of competing for time, and a music game of playing the same piece and competing for a reward. The game may not necessarily be a competition game.

[Fourth Modification]

In the above-described embodiment, a configuration of giving three types of rewards, namely a provider reward, a player reward, and a viewer reward is shown. However, one or two of these rewards may be omitted.

[Fifth Modification]

In the above-described embodiment, the present provided once remains in the present queue 60 (see FIG. 4) unless the present is not used. However, the remaining time period for the queue may be a limited time period.

Specifically, a step is added to search a present of which a limited time period has passed in the present provision history data 740 from the provision date and time 746 of the present and to delete the present from the present queue 60. The present deleted from the present queue 60 may be just eliminated or returned to the viewer who is the provider. That is, provision of a present in this configuration corresponds to a temporary provision. With this configuration, a newer present suitable for game situation can be set in the present queue 60 (that is, an old present is deleted from the present queue 60).

The limited time period may be a common predetermined value for all presents, or may be set proportional to the applied queue rank each time such that the higher the rank, the longer the time. In this case, information on date and time on which the present will be deleted may be added to the present provision history data 740 after a limited time period has been passed from a set limited time period or the provision date and time. Alternatively, in the configuration, the limited time period may be set by the provider of the present.

[Sixth Modification]

Also, in the above-described embodiment, an item is shown as an example of a present (an assistance object) to the player. However, for example, game parameter values such as vitality or magical power that are consumed in association with an action of the character, a skill, an attack technique that can be exerted, or the like, may be set according to the content of the game. When a game parameter value is given, the game parameter value of the player character of the player who receives the present may be updated by the given amount. When a skill or an attack technique that can be exerted is given, the given skill or the attack technique may be given to the player character of the player who receives the present. At that time, the player is preferably deprived of the given skill or the attack technique after the play.

[Seventh Modification]

In the above-described embodiment, the content of the provided present is disclosed to the player. Specifically, in the present selection window 73 in FIG. 9, the item image 75 of the present to be given and the unused remaining number 76 in the package are displayed by package in association with each other. The content of the present is also clarified by the present generation notification 78.

However, these may be non-disclosed. For example, a design image of a “question mark” or a “treasure chest” may be displayed instead of displaying the item image 75 and the remaining unused number 76 such that the player cannot know the content. Note that not all present are non-disclosed and can be determined to be disclosed/non-disclosed by a lottery at the timing when the present is provided.

Also, an operation input may be added for the player to select whether the target of use of the present is an own character or the other (an opponent in the above-described embodiment) player character when the present use operation is performed.

Also, in the above-described embodiment, the item to be given is basically beneficial to the receiver, however, a damaging item that may be drawback to the target user of the item may be included. For example, a bomb item that will give damage to the opponent who has thrown the item may be included.

Also, three configurations, namely, a configuration of non-disclosure of the content of the above-described present, a configuration to allow the player to select a target user of the present, and a configuration to enable selection of damaging item as a present, may be implemented together.

In the configuration in which these three configurations are implemented, the viewer can select two ways of positive and negative assistances: in one way by giving a beneficial item as a present to the player to whom the viewer wants to assist, and in another way by giving a damaging item as a present to the opponent. By contrast, the player selects and uses the item with excitement without knowing whether the received item is a beneficial item or a damaging item, or whether the item is used for the player or the opponent. This can increase interests of esports distribution.

[Eighth Modification]

Also, in the above-described embodiment or modification, a configuration may be added in which a present is randomly selected from the items possessed by the viewer when the viewer selects a present.

Specifically, a “random selection” icon is displayed in the present operation section 30 (see FIG. 3) and controlled such that when the icon is operated, the types and quantity of items to be given is randomly selected from the items possessed by the viewer. At this time, if the content designation section 43 in the present detail setting screen W4 is displayed as a predetermined “unknown” display or a display is omitted, the viewer does not know the content of the present either. This may further enhance interests.

What is claimed is:

1. A computer system comprising:
a processor; and
a storage device storing a program,
the processor executing the program for
providing information for displaying a gameplay image played by using an object based on a use operation of a player user on a viewer terminal of a viewer user;
performing an assistance control of giving the object for the assistance to the player user by accepting an assistance instruction for assisting the player user from the viewer terminal and giving the object from the viewer user to the player user; and
performing a reward giving control of giving a reward to a viewer user who gave the assistance object and/or to the player user based on whether the assistance object is used or not used by the player.

2. The computer system as defined in claim 1,
the assistance control including a control of selecting the assistance object among possessed objects of the viewer user according to a selection operation instruction by the viewer user and giving the assistance object to the player user.

3. The computer system as defined in claim 1,
the assistance control including a control of purchasing the assistance object and giving the assistance object to the player user according to a purchase operation instruction by the viewer user.

4. The computer system as defined in claim 2,
the assistance control including a control of purchasing the assistance object and giving the assistance object to the player user according to a purchase operation instruction by the viewer user.

5. The computer system as defined in claim 1,
the processor executing the program for further controlling a progress of the game by changing exerted effects according to a timing of provision of the assistance object by the assistance control when a progress of the game is controlled by using the assistance object based on a use operation of the player user.

6. The computer system as defined in claim 4,
the processor executing the program for further controlling a progress of the game by changing exerted effects according to a timing of provision of the assistance object by the assistance control when a progress of the game is controlled by using the assistance object based on a use operation of the player user.

7. The computer system as defined in claim 1,
the reward giving control including changing a content of the reward according to a timing of provision of the assistance object by the assistance control when the assistance object is used.

8. The computer system as defined in claim 6,
the reward giving control including changing a content of the reward according to a timing of provision of the assistance object by the assistance control when the assistance object is used.

9. The computer system as defined in claim 1, the assistance control including accepting the assistance instruction from a plurality of the viewer users; giving a plurality of the assistance objects to the player user,
the processor executing the program for further performing a selection list control that variably controls a display rank of the assistance object, the assistance object being displayed in a selection list when the player user selects the assistance object for use in the game.

10. The computer system as defined in claim 8,
the assistance control including accepting the assistance instruction from a plurality of the viewer users; giving a plurality of the assistance objects to the player user,
the processor executing the program for further performing a selection list control that variably controls a display rank of the assistance object, the assistance object being displayed in a selection list when the player user selects the assistance object for use in the game.

11. The computer system as defined in claim 9,
the selection list control including variably controlling the display rank according to a timing at which the assistance object is given by the assistance control.

12. The computer system as defined in claim 10,
the selection list control including variably controlling the display rank according to a timing at which the assistance object is given by the assistance control.

13. The computer system as defined in claim 9,
the assistance control including accepting the assistance instruction and giving the assistance object to the player user, the assistance instruction being performed as a whole in one operation or automatically used intermittently or continuously with a package as a unit,
the selection list control including variably controlling the display rank with a package of the assistance object as a unit.

14. The computer system as defined in claim 10,
the assistance control including accepting the assistance instruction and giving the assistance object to the player user, the assistance instruction being performed as a whole in one operation or automatically used intermittently or continuously with a package as a unit,
the selection list control including variably controlling the display rank with a package of the assistance object as a unit.

15. The computer system as defined in claim 13,
the selection list control including variably controlling the display rank according to a content of the package of the assistance object.

16. The computer system as defined in claim 14,
the selection list control including variably controlling the display rank according to a content of the package of the assistance object.

17. The computer system as defined in claim 9,
the selection list control including variably controlling the display rank according to whether a relationship between the viewer user who gave the assistance object and the player user is a predetermined relationship.

18. The computer system as defined in claim 16,
the selection list control including variably controlling the display rank according to whether a relationship between the viewer user who gave the assistance object and the player user is a predetermined relationship.

19. The computer system as defined in claim 6,
the selection list control including variably controlling the display rank according to intimacy between the viewer user who gave the assistance object and the player user.

20. The computer system as defined in claim 18,
the selection list control including variably controlling the display rank according to intimacy between the viewer user who gave the assistance object and the player user.

21. The computer system as defined in claim 19,
the reward giving control including giving a reward as the reward of increasing the intimacy between the viewer user who gave the assistance object and the player user when the assistance object is used.

22. The computer system as defined in claim 20,
the reward giving control including giving a reward as the reward of increasing the intimacy between the viewer user who gave the assistance object and the player user when the assistance object is used.

23. The computer system as defined in claim 1,
the reward giving control including changing a content of the reward based on a result of the game.

24. The computer system as defined in claim 1,
the reward giving control including changing a content of the reward based on a type and/or quantity of the assistance object that has been used in the game.

25. The computer system as defined in claim 1,
the processor executing the program for further implementing notification, wherein the notification is performed to the player terminal of the player user every time the assistance object is given to the player user by the assistance control.

26. A game system comprising:
a server system that is the computer system as defined in claim 1, and
the viewer terminal.
